(19) United States
(12) Patent Application Publication
(10) Pub. No.: US 2025/0173918 A1
(43) Pub. Date: May 29, 2025

(54) COMMUNICATION TERMINAL, DISPLAY METHOD, AND NON-TRANSITORY RECORDING MEDIUM

(71) Applicants: Takeshi HORIUCHI, Tokyo (JP); Shiori UEDA, Sagamihara (JP); Hidekuni ANNAKA, Saitama (JP); Takeshi HOMMA, Saitama (JP)

(72) Inventors: Takeshi HORIUCHI, Tokyo (JP); Shiori UEDA, Sagamihara (JP); Hidekuni ANNAKA, Saitama (JP); Takeshi HOMMA, Saitama (JP)

(21) Appl. No.: 18/953,086

(22) Filed: Nov. 20, 2024

(30) Foreign Application Priority Data
Nov. 29, 2023 (JP) 2023-201739

(51) Int. Cl. G06T 11/00; G06T 7/70; G06V 40/10; G06V 40/20

(52) U.S. Cl. CPC G06T 11/00; G06T 7/70; G06V 40/10; G06V 40/20; G06T 2207/30201

(57) ABSTRACT

A communication terminal includes circuitry configured to receive, from another communication terminal, a wide-field-of-view image; display a particular area image corresponding to a particular area of the wide-field-of-view image; and display an icon, corresponding to a non-verbal communication of a person, at a position in the particular area image in a case that the non-verbal communication is detected in an area of the wide-field-of-view image outside of the particular area.

### CROSS-REFERENCE TO RELATED APPLICATION

This patent application is based on and claims priority pursuant to 35 U.S.C. § 119(a) to Japanese Patent Application No. 2023-201739, filed on Nov. 29, 2023, in the Japan Patent Office, the entire disclosure of which is hereby incorporated by reference herein.

### BACKGROUND

### Technical Field

The present disclosure relates to a communication terminal, a display method, and a non-transitory recording medium.

### Description of the Related Art

Videoconference systems are now in widespread use, allowing users at remote places to hold a meeting via a communication network such as the Internet. In such videoconference systems, a communication terminal for a remote conference system is provided in a conference room where attendants of one party in a remote conference are attending. This communication terminal collects an image or video of the conference room including the attendants and sound such as speech made by the attendants, and transmits digital data converted from the collected image (video) and/or sound to the other party's terminal provided at a different conference room. Based on the transmitted digital data, the other party's terminal displays images on a display or outputs audio from a speaker in the different conference room to enable video calling. This enables to carry out a conference among remote sites, in a state close to an actual conference.

### SUMMARY

A communication terminal in accordance with the present disclosure includes circuitry configured to receive, from another communication terminal, a wide-field-of-view image; display a particular area image corresponding to a particular area of the wide-field-of-view image; and display an icon, corresponding to a non-verbal communication of a person, at a position in the particular area image in a case that the non-verbal communication is detected in an area of the wide-field-of-view image outside of the particular area.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1A is a left side view of an image capturing device according to an embodiment of the present disclosure;

FIG. 1B is a front view of the image capturing device of FIG. 1A;

FIG. 1C is a plan view of the image capturing device of FIG. 1A;

FIG. 2 illustrates how a user uses the image capturing device, according to an embodiment of the present disclosure;

FIG. 3A is a view illustrating a front side of a hemispherical image captured by the image capturing device according to an embodiment of the present disclosure;

FIG. 3B is a view illustrating a back side of the hemispherical image captured by the image capturing device according to an embodiment of the present disclosure;

FIG. 3C is a view illustrating an image captured by the image capturing device represented by Mercator projection according to an embodiment of the present disclosure;

FIG. 4A illustrates how the image represented by Mercator projection covers a surface of a sphere according to an embodiment of the present disclosure;

FIG. 4B is a view illustrating a full spherical image according to an embodiment of the present disclosure;

FIG. 5 is a view illustrating positions of a virtual camera and a predetermined area in a case in which the full spherical image is represented as a three-dimensional solid sphere according to an embodiment of the present disclosure;

FIG. 6A is a perspective view of FIG. 5;

FIG. 6B is a view illustrating an image of the predetermined area on a display of a communication terminal according to an embodiment of the present disclosure;

FIG. 7 is a view illustrating a relation between predetermined-area information and a predetermined-area image according to an embodiment of the present disclosure;

FIG. 8 is a schematic diagram illustrating a configuration of an image communication system according to an embodiment of the present disclosure;

FIG. 9 is a schematic block diagram illustrating a hardware configuration of the image capturing device according to an embodiment of the present disclosure;

FIG. 10 is a schematic block diagram illustrating a hardware configuration of a videoconference terminal, according to an embodiment of the present disclosure;

FIG. 11 is a schematic block diagram illustrating a hardware configuration of any one of a communication management system and a personal computer (PC), according to an embodiment of the present disclosure;

FIG. 12 is a schematic block diagram illustrating a hardware configuration of a smartphone, according to an embodiment of the present disclosure;

FIGS. 13A, 13B and 13C illustrate a functional configuration of the image communication system according to an embodiment of the present disclosure;

FIG. 14 is a conceptual diagram illustrating an image type management table, according to an embodiment of the present disclosure;

FIG. 15 is a conceptual diagram illustrating an image capturing device management table, according to an embodiment of the present disclosure;

FIG. 16 is a conceptual diagram illustrating an non-verbal communication management table, according to an embodiment of the present disclosure;

FIG. 17 is a conceptual diagram illustrating a session management table, according to an embodiment of the present disclosure;

FIG. 18 is a conceptual diagram illustrating an image type management table;

FIG. 19 is a sequence diagram illustrating an operation of participating in a specific communication session according to an embodiment of the present disclosure;

FIG. 20 is a view illustrating a selection screen for accepting selection of a desired communication session (virtual conference), according to an embodiment of the present disclosure;

FIG. 21 is a sequence diagram illustrating an operation of managing image type information, according to an embodiment of the present disclosure;

FIG. 22 is a sequence diagram illustrating an image data transmission process in video calling, according to an embodiment of the present disclosure;

FIG. 23A illustrates an example state of video calling in a case which the image capturing device of FIGS. 1A to 1C is not used, according to an embodiment of the present disclosure;

FIG. 23B illustrates an example state of video calling in a case which the image capturing device of FIGS. 1A to 1C is used, according to an embodiment of the present disclosure;

FIG. 24 is a flowchart illustrating the display process on the display at site B.

FIG. 25 is a diagram illustrates a full sphere image represented as an equirectangular projection image.

FIG. 26 is a diagram illustrates a state in which each user has been detected in addition to the diagram shown in FIG. 25.

FIG. 27 is a diagram illustrates the distance between user A3 and the periphery of a predetermined area in addition to the diagram shown in FIG. 26.

FIG. 28 illustrates an example of the display on the display at site B.

FIG. 29 illustrates an example of the display on the display at site B.

FIG. 30 illustrates an example of the display on the display at site B.

FIG. 31 is a sequence diagram illustrating another example of the management process of image type information.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the multiple forms as well, unless the context clearly indicates otherwise.

Referring to the drawings, several embodiments of the present invention are described.

### Overview of Embodiment

### <Generation of Full Spherical Image>

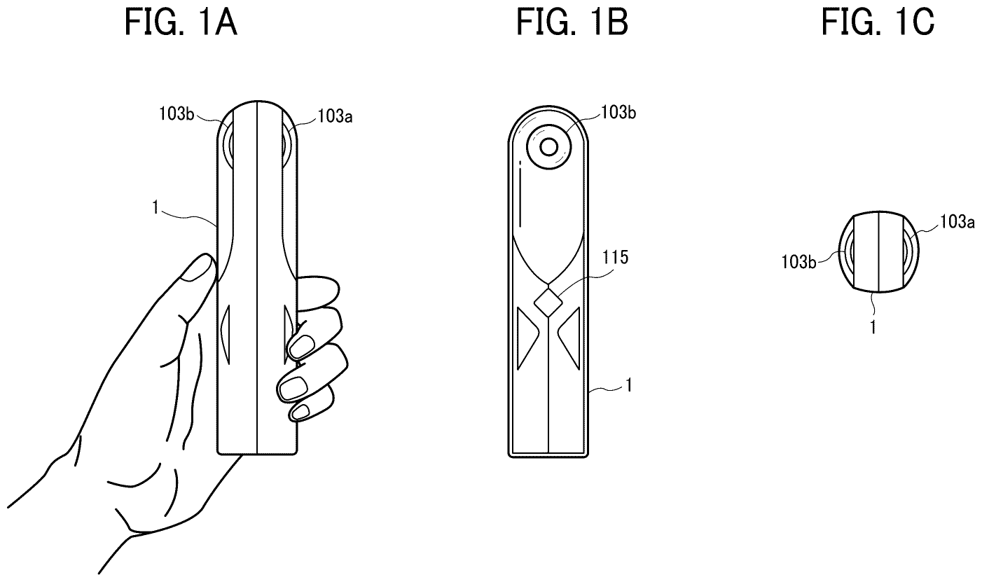

With reference to FIGS. 1 to 7, a description is given of generating a full spherical image. The full spherical image is also called a full spherical panoramic image or a 360° panoramic image, and is an example of a wide-field-of-view video having a wide range of viewing angles. Wide-field-of-view images also include simple panoramic images of about 1800.

First, a description is given of an external view of an image capturing device 1, with reference to FIGS. 1A to 1C. The image capturing device 1 is a digital camera for capturing images from which a 360-degree full spherical image is generated. FIGS. 1A to 1C are respectively a left side view, a front view, and a plan view of the image capturing device 1.

As illustrated in FIG. 1A, the image capturing device 1 has a shape such that one can hold it with one hand. Further, as illustrated in FIGS. 1A to 1C, an imaging element 103a is provided on a front side (anterior side) of an upper section of the image capturing device 1, and an imaging element 103b is provided on a back side (rear side) thereof. These imaging elements (image sensors) 103a and 103b are used in combination with optical members (e.g., fisheye lenses 102a and 102b, described later), each being capable of capturing a hemispherical image having an angle of view of 180 degrees or wider. Furthermore, as illustrated in FIG. 1B, an operation unit 115 such as a shutter button is provided on an opposite side of the front side of the image capturing device 1.

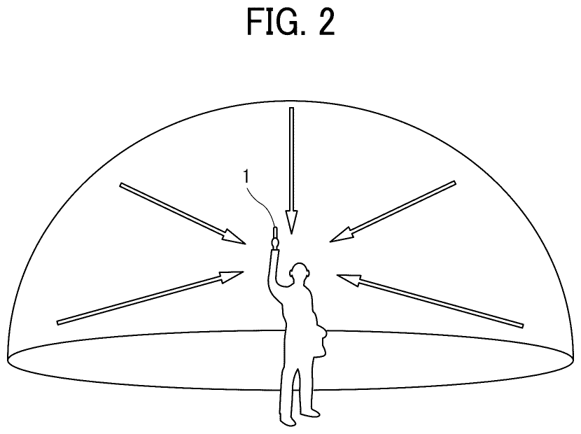

Hereinafter, a description is given of a situation where the image capturing device 1 is used, with reference to FIG. 2. FIG. 2 illustrates an example of how a user uses the image capturing device 1. As illustrated in FIG. 2, for example, the image capturing device 1 is used for capturing objects surrounding the user who is holding the image capturing device 1 in his/her hand. The imaging elements 103a and 103b illustrated in FIGS. 1A to 1C capture the objects surrounding the user to obtain two hemispherical images.

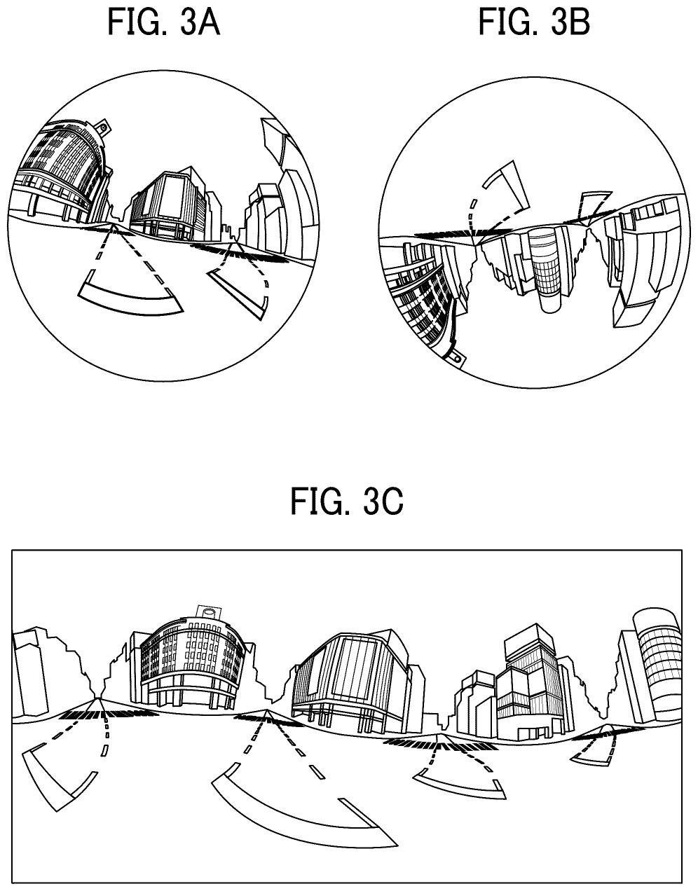

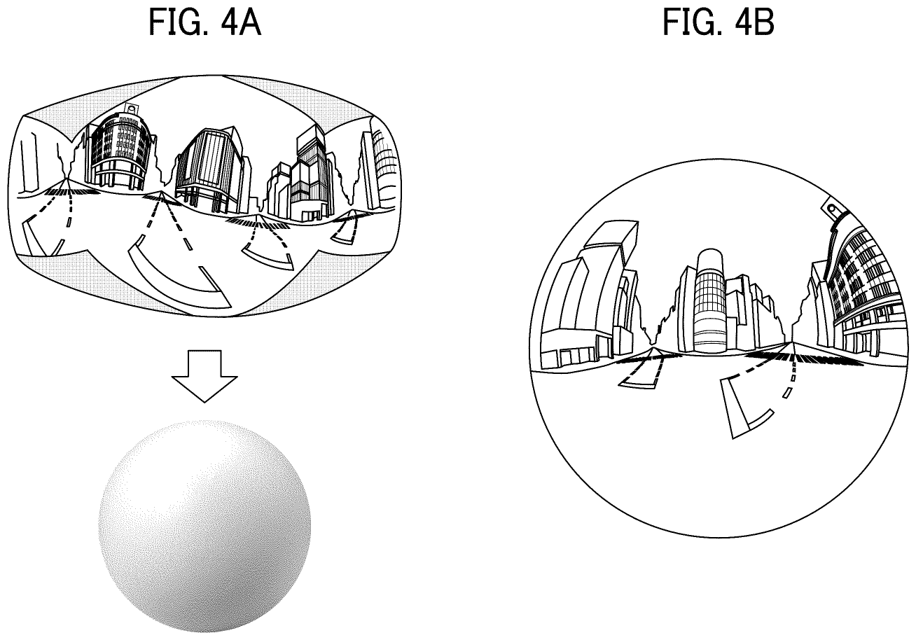

Hereinafter, a description is given of an overview of an operation of generating the full spherical image from the image captured by the image capturing device 1, with reference to FIGS. 3A to 3C and FIGS. 4A and 4B. FIG. 3A is a view illustrating a hemispherical image (front side) captured by the image capturing device 1. FIG. 3B is a view illustrating a hemispherical image (back side) captured by the image capturing device 1. FIG. 3C is a view illustrating an image represented by Mercator projection. The image represented by Mercator projection as illustrated in FIG. 3C is referred to as a “Mercator image” hereinafter. FIG. 4A illustrates an example of how the Mercator image covers a surface of a sphere. FIG. 4B is a view illustrating the full spherical image.

As illustrated in FIG. 3A, an image captured by the imaging element 103a is a curved hemispherical image (front side) taken through the fisheye lens 102a described later. Also, as illustrated in FIG. 3B, an image captured by the imaging element 103b is a curved hemispherical image (back side) taken through the fisheye lens 102b described later. The hemispherical image (front side) and the hemispherical image (back side), which is reversed by 180-degree from each other, is combined by the image capturing device 1. Thus, the Equirectangular projection image as illustrated in FIG. 3C is generated.

The Mercator image is pasted on the sphere surface using Open Graphics Library for Embedded Systems (OpenGL ES) as illustrated in FIG. 4A. Thus, the full spherical image as illustrated in FIG. 4B is generated. In other words, the full spherical image is represented as the Mercator image facing toward a center of the sphere. It should be noted that OpenGL ES is a graphic library used for visualizing two-dimensional (2D) and three-dimensional (3D) data. The full spherical image is either a still image or a movie.

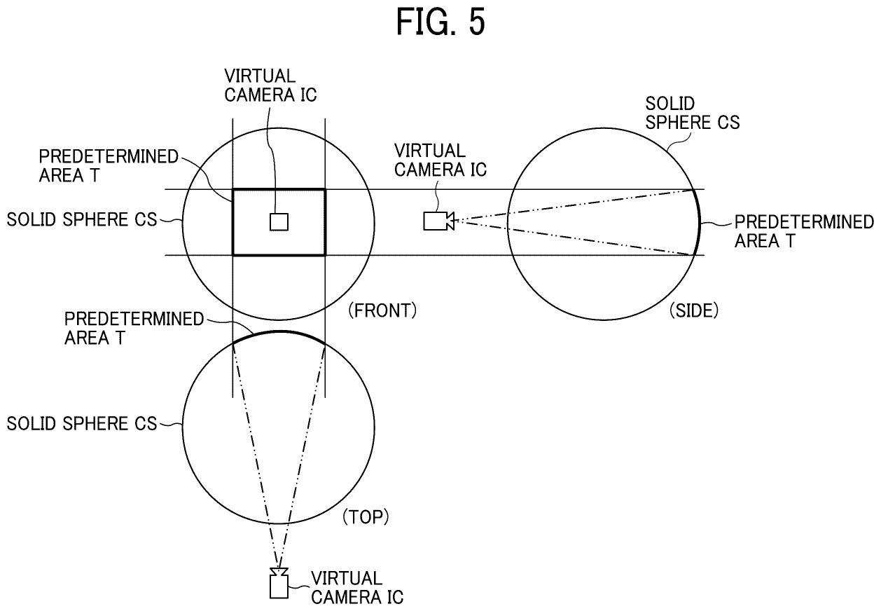

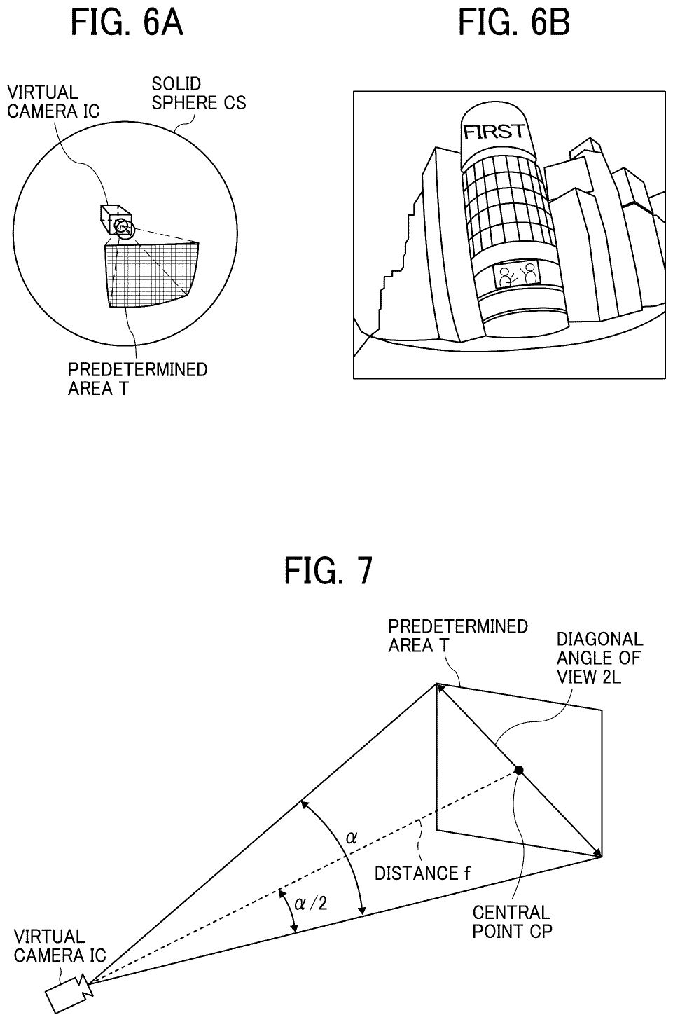

One may feel strange viewing the full spherical image, because the full spherical image is an image attached to the sphere surface. To resolve this strange feeling, an image of a predetermined area, which is a part of the full spherical image, is displayed as a planar image having fewer curves. The image of the predetermined area is referred to as a “predetermined-area image” hereinafter. Hereinafter, a description is given of displaying the predetermined-area image with reference to FIG. 5 and FIGS. 6A and 6B.

FIG. 5 is a view illustrating positions of a virtual camera IC and a predetermined area T in a case in which the full spherical image is represented as a three-dimensional solid sphere. The virtual camera IC corresponds to a position of a point of view (viewpoint) of a user who is viewing the full spherical image represented as the three-dimensional solid sphere. FIG. 6A is a perspective view of FIG. 5. FIG. 6B is a view illustrating the predetermined-area image displayed on a display. In FIG. 6A, the full spherical image illustrated in FIG. 4B is represented as a three-dimensional solid sphere CS. Assuming that the generated full spherical image is the solid sphere CS, the virtual camera IC is outside of the full spherical image as illustrated in FIG. 5. The predetermined area T in the full spherical image is an imaging area of the virtual camera IC. Specifically, the predetermined area T is specified by predetermined-area information indicating a position coordinate (x(rH), y(rV), angle of view a (angle)) including an angle of view of the virtual camera IC in a three-dimensional virtual space containing the full spherical image. Zooming of the predetermined area T is implemented by enlarging or reducing a range (arc) of the angle of view a. Further, zooming of the predetermined area T is implemented by moving the virtual camera IC toward or away from the full spherical image.

The predetermined-area image, which is an image of the predetermined area T illustrated in FIG. 6A, is displayed as an imaging area of the virtual camera IC, as illustrated in FIG. 6B. FIG. 6B illustrates the predetermined-area image represented by the predetermined-area information that is set by default. In another example, the predetermined-area image may be specified by an imaging area (X, Y, Z) of the virtual camera IC, i.e., the predetermined area T, rather than the predetermined-area information, i.e., the position coordinate of the virtual camera IC. A description is given hereinafter using the position coordinate (x(rH), y(rV), and an angle of view a (angle)) of the virtual camera IC.

Hereinafter, a description is given of a relation between the predetermined-area information and the predetermined area T with reference to FIG. 7. FIG. 7 is a view illustrating a relation between the predetermined-area information and the predetermined area T. As illustrated in FIG. 7, a center point CP of 2L provides the parameters (x, y) of the predetermined-area information, where 2L denotes a diagonal angle of view of the predetermined area T specified the angle of view a of the virtual camera IC. f is the distance from the virtual camera IC to the center point CP. L is a distance between the center point CP and a given vertex of the predetermined area T (2L is a diagonal line). In FIG. 7, a trigonometric function equation generally expressed by the following equation (1) is satisfied.

$$L / f = tan ( α / 2 ) \qquad ( Equation 1 )$$

### <Overview of Image Communication System>

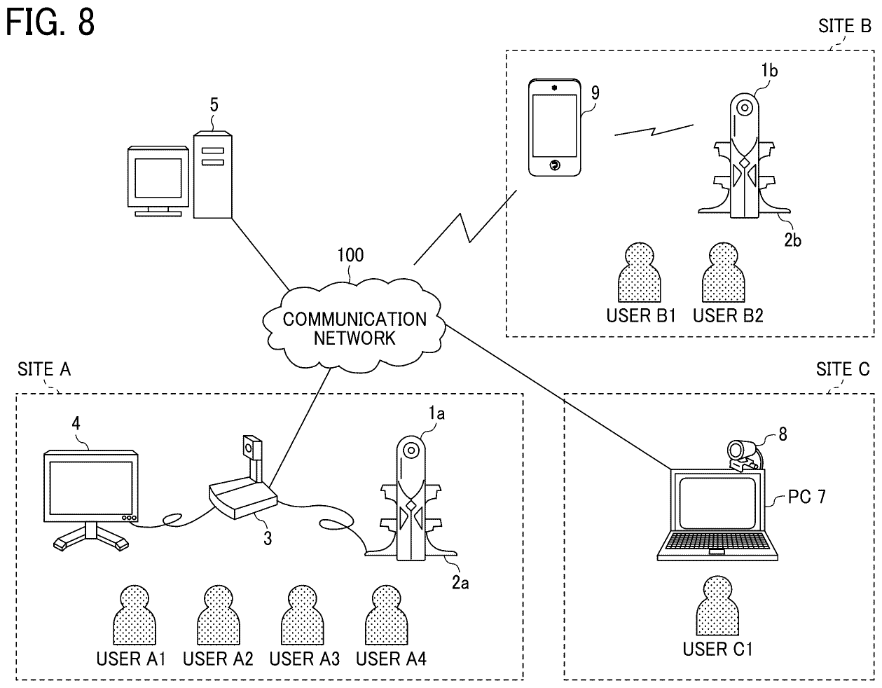

Hereinafter, a description is given of an overview of a configuration of an image communication system according to this embodiment with reference to FIG. 8. FIG. 8 is a schematic diagram illustrating a configuration of the image communication system according to this embodiment.

As illustrated in FIG. 8, the image communication system according to this embodiment includes an image capturing device 1a, an image capturing device 1b, a videoconference terminal 3, a display 4, a communication management system 5, a personal computer (PC) 7, an image capturing device 8, and a smartphone 9. The videoconference terminal 3, the smartphone 9, the PC 7, and the videoconference terminal 3d communicate data with one another via a communication network 100 such as the Internet. The communication network 100 may be either a wireless network or a wired network. In an exemplary implementation, the videoconference terminal 3, the smartphone 9, the PC 7, and the videoconference terminal 3d communicate data with one another to initiate a conference or meeting, or another communication event, communication activity or occurrence.

The image capturing device 1a and the image capturing device 1b are each a special digital camera, which captures an image of a subject or surroundings to obtain two hemispherical images, from which a full spherical image is generated, as described above. By contrast, the image capturing device 8 is a general-purpose digital camera that captures an image of a subject or surroundings to obtain a general planar image.

The videoconference terminals 3 are each a terminal dedicated to videoconferencing. The videoconference terminal 3 display an image of video calling on the displays 4, respectively, via a wired cable such as a universal serial bus (USB). The videoconference terminal 3 usually captures an image by a camera 312, which is described later. However, in a case in which the videoconference terminal 3 is connected to a cradle 2a on which the image capturing device 1a is mounted, the image capturing device 1a is preferentially used. Accordingly, two hemispherical images are obtained, from which a full spherical image is generated. When a wired cable is used for connecting the videoconference terminal 3 and the cradle 2a, the cradle 2a not only enables communications between the image capturing device 1a and the videoconference terminal 3 but also supplies power with the image capturing device 1a and holds the image capturing device 1a. In this disclosure, the image capturing device 1a, the cradle 2a, the videoconference terminal 3, and the display 4a are located at the same site A. In the site A, four users A1, A2, A3 and A4 are participating in video calling.

The communication management system 5 manages and controls communication of the videoconference terminal 3, the PC 7 and the smartphone 9. Further, the communication management system 5 manages types (a general image type and a special image type) of image data exchanged. Therefore, the communication management system 5 also operates as a communication control system. In this disclosure, the special image is a full spherical image. The communication management system 5 is located, for example, at a service provider that provides video communication service. In one example, the communication management system 5 is configured as a single computer. In another example, the communication management system 5 is constituted as a plurality of computers to which divided portions (functions, means, or storages) are arbitrarily allocated. In other words, the communication management system 5 may be implemented by a plurality of servers that operate in cooperation with one another.

The PC 7 performs video calling with the image capturing device 8 connected thereto. In this disclosure, the PC 7 and the image capturing device 8 are located at the same site C. At the site C, one user C is participating in video calling.

The smartphone 9 includes a display 917, which is described later, and displays an image of video calling on the display 917. The smartphone 9 includes a complementary metal oxide semiconductor (CMOS) sensor 905, and usually captures an image with the CMOS sensor 905. In addition, the smartphone 9 is also capable of obtaining data of two hemispherical images captured by the image capturing device 1b, based on which the full spherical image is generated, by wireless communication such as Wireless Fidelity (Wi-Fi) and Bluetooth (registered trademark). In a case in which wireless communication is used for obtaining data of two hemispherical images, a cradle 2b just supplies power with the image capturing device 1b and holds the image capturing device 1b. In this disclosure, the image capturing device 1b, the cradle 2b, and the smartphone 9 are located at the same site B. Further, in the site B, two users B1 and B2 are participating in video calling.

The videoconference terminal 3, the PC 7 and the smartphone 9 are each an example of a communication terminal. OpenGL ES is installed in each of those communication terminals to enable each communication terminal to generate predetermined-area information that indicates a partial area of a full spherical image, or to generate a predetermined-area image from a full spherical image that is transmitted from a different communication terminal.

The arrangement of the terminals, apparatuses and users illustrated in FIG. 8 is just an example, and any other suitable arrangement will suffice. For example, in the site C, an image capturing device that is capable of performing image capturing for a full spherical image may be used in place of the image capturing device 8. In addition, examples of the communication terminal include a digital television, a smartwatch, and a car navigation device. Hereinafter, any arbitrary one of the image capturing device 1a and the image capturing device 1b is referred to as “image capturing device 1”.

### <Hardware Configuration According to Embodiment>

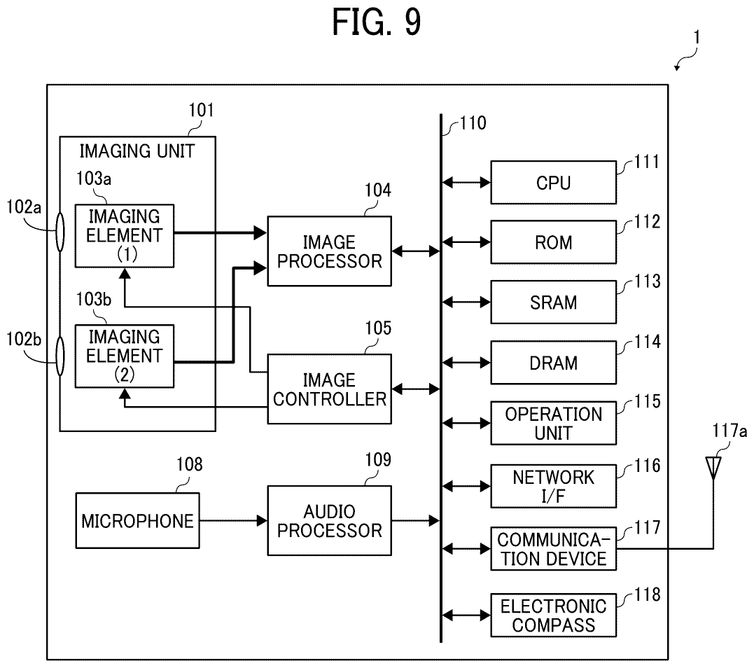

Hereinafter, a description is given of hardware configurations of the image capturing device 1, the videoconference terminal 3, the communication management system 5, the PC 7, and the smartphone 9 according to this embodiment, with reference to FIGS. 9 to 12. Since the image capturing device 8 is a general-purpose camera, a detailed description thereof is omitted.

Moreover, the components of the image capturing device 1, the videoconference terminal 3, the communication management system 5, the PC 7, and the smartphone 9 may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform functionality disclosed below. Processors are considered processing circuitry or circuitry as they include transistors and other circuitry therein. In the disclosure, the circuitry, units, devices or means are hardware that carry out or are programmed to perform the functionality. The hardware may be any hardware disclosed herein which is programmed or configured to carry out the functionality.

### <Hardware Configuration of Image Capturing Device 1>

First, a description is given of a hardware configuration of the image capturing device 1, with reference to FIG. 9. FIG. 9 is a block diagram illustrating a hardware configuration of the image capturing device 1. A description is given hereinafter of a case in which the image capturing device 1 is a full spherical (omnidirectional) image capturing device having two imaging elements. However, the image capturing device 1 may include any suitable number of imaging elements, providing that it includes at least two imaging elements. In addition, the image capturing device 1 is not necessarily an image capturing device dedicated to omnidirectional image capturing. Alternatively, an external omnidirectional image capturing unit may be attached to a general-purpose digital camera or a smartphone to implement an image capturing device having substantially the same function as that of the image capturing device 1.

As illustrated in FIG. 9, the image capturing device 1 includes an imaging unit 101, an image processing unit 104, an imaging control unit 105, a microphone 108, an audio processing unit 109, a central processing unit (CPU) 111, a read only memory (ROM) 112, a static random access memory (SRAM) 113, a dynamic random access memory (DRAM) 114, an operation unit 115, a network interface (I/F) 116, a communication device 117, and an antenna 117a.

The imaging unit 101 includes two wide-angle lenses (so-called fish-eye lenses) 102a and 102b, each having an angle of view of equal to or greater than 180 degrees so as to form a hemispherical image. The imaging unit 101 further includes the two imaging elements 103a and 103b corresponding to the wide-angle lenses 102a and 102b respectively. The imaging elements 103a and 103b each includes an image sensor such as a CMOS sensor and a charge-coupled device (CCD) sensor, a timing generation circuit, and a group of registers. The image sensor converts an optical image formed by the fisheye lenses 102a and 102b into electric signals to output image data. The timing generation circuit generates horizontal or vertical synchronization signals, pixel clocks and the like for the image sensor. Various commands, parameters and the like for operations of the imaging elements 103a and 103b are set in the group of registers.

Each of the imaging elements 103a and 103b of the imaging unit 101 is connected to the image processing unit 104 via a parallel I/F bus. In addition, each of the imaging elements 103a and 103b of the imaging unit 101 is connected to the imaging control unit 105 via a serial I/F bus such as an I2C bus. The image processing unit 104 and the imaging control unit 105 are each connected to the CPU 111 via a bus 110. Furthermore, the ROM 112, the SRAM 113, the DRAM 114, the operation unit 115, the network I/F 116, the communication device 117, and the electronic compass 118 are also connected to the bus 110.

The image processing unit 104 acquires image data from each of the imaging elements 103a and 103b via the parallel I/F bus and performs predetermined processing on each image data. Thereafter, the image processing unit 104 combines these image data to generate data of the Mercator image as illustrated in FIG. 3C.

The imaging control unit 105 usually functions as a master device while the imaging elements 103a and 103b each usually functions as a slave device. The imaging control unit 105 sets commands and the like in the group of registers of the imaging elements 103a and 103b via the I2C bus. The imaging control unit 105 receives necessary commands from the CPU 111. Further, the imaging control unit 105 acquires status data of the group of registers of the imaging elements 103a and 103b via the I2C bus. The imaging control unit 105 sends the acquired status data to the CPU 111.

The imaging control unit 105 instructs the imaging elements 103a and 103b to output the image data at a time when the shutter button of the operation unit 115 is pressed. The image capturing device 1 may display a preview image on a display (e.g., a display of the videoconference terminal 3) or may support displaying movie. In this case, the image data are continuously output from the imaging elements 103a and 103b at a predetermined frame rate (frames per minute).

Furthermore, the imaging control unit 105 operates in cooperation with the CPU 111 to synchronize times when the imaging elements 103a and 103b output the image data. It should be noted that although in this embodiment, the image capturing device 1 does not include a display unit (display), the image capturing device 1 may include the display.

The microphone 108 converts sounds to audio data (signal). The audio processing unit 109 acquires the audio data from the microphone 108 via an I/F bus and performs predetermined processing on the audio data.

The CPU 111 is circuitry that controls an entire operation of the image capturing device 1 and performs necessary processing. The ROM 112 stores various programs for the CPU 111. The SRAM 113 and the DRAM 114 each operates as a work memory to store programs loaded from the ROM 112 for execution by the CPU 111 or data in current processing. More specifically, the DRAM 114 stores image data currently processed by the image processing unit 104 and data of the Mercator image on which processing has been performed.

The operation unit 115 collectively refers to various operation keys, a power switch, the shutter button, and a touch panel having functions of both displaying information and receiving input from a user, which may be used in combination. The user operates the operation keys to input various photographing modes or photographing conditions.

The network I/F 116 collectively refers to an interface circuit such as a USB I/F that allows the image capturing device 1 to communicate data with an external media such as an SD card or an external personal computer. The network I/F 116 supports at least one of wired and wireless communications. The data of the Mercator image, which is stored in the DRAM 114, is stored in the external media via the network I/F 116 or transmitted to the external device such as the videoconference terminal 3 via the network I/F 116, as needed.

The communication device 117 communicates data with an external device such as the videoconference terminal 3 via the antenna 117a of the image capturing device 1 by near distance wireless communication such as Wi-Fi and Near Field Communication (NFC). The communication device 117 is also capable of transmitting the data of Mercator image to the external device such as the videoconference terminal 3.

The electronic compass 118 calculates an orientation and a tilt (roll angle) of the image capturing device 1 from the Earth's magnetism to output orientation and tilt information. This orientation and tilt information is an example of related information, which is metadata described in compliance with Exif. This information is used for image processing such as image correction of captured images. Further, the related information also includes a date and time when the image is captured by the image capturing device 1, and a size of the image data.

### <Hardware Configuration of Videoconference Terminal 3>

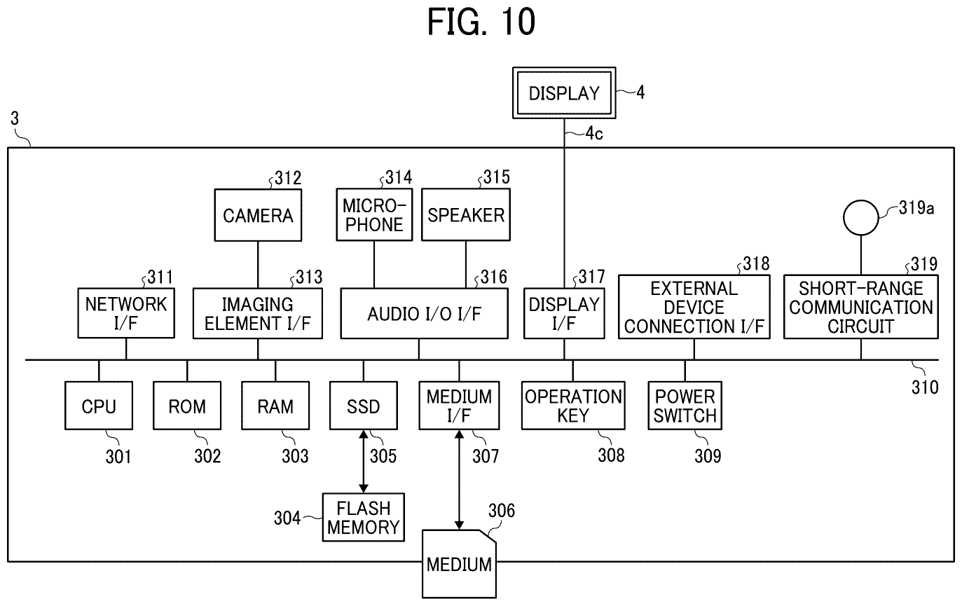

Hereinafter, a description is given of a hardware configuration of the videoconference terminal 3 with reference to FIG. 10. FIG. 10 is a block diagram illustrating a hardware configuration of the videoconference terminal 3s illustrated in FIG. 10, the videoconference terminal 3 includes a CPU 301, a ROM 302, a RAM 303, a flash memory 304, a solid state drive (SSD) 305, a medium I/F 307, an operation key 308, a power switch 309, a bus line 310, a network I/F 311, a camera 312, an imaging element I/F 313, a microphone 314, a speaker 315, an audio input/output interface 316, a display I/F 317, an external device connection I/F 318, a near-distance communication circuit 319, and an antenna 319a for the near-distance communication circuit 319.

The CPU 301 is circuitry controls an entire operation of the videoconference terminal 3. The ROM 302 stores a control program for operating the CPU 301 such as an Initial Program Loader (IPL). The RAM 303 is used as a work area for the CPU 301. The flash memory 304 stores various data such as a communication control program, image data, and audio data. The SSD 305 controls reading or writing of various data to and from the flash memory 304 under control of the CPU 301. A hard disk drive (HDD) may be used in place of the SSD 305. The medium I/F 307 controls reading or writing (storing) of data with respect to a recording medium 306 such as a flash memory. The operation key 308 is operated by a user to input a user instruction such as a user selection of a destination of the videoconference terminal 3. The power switch 309 is a switch that turns on or off the power of the videoconference terminal 3.

The network I/F 311 allows communication of data with an external device through the communication network 100 such as the Internet. The camera 312 is an example of a built-in imaging device capable of capturing a subject under control of the CPU 301 to obtain image data. The imaging element I/F 313 is a circuit that controls driving of the camera 312. The microphone 314 is an example of a built-in audio collecting device capable of inputting audio. The audio input/output interface 316 is a circuit for controlling input and output of audio signals between the microphone 314 and the speaker 315 under control of the CPU 301. The display I/F 317 is a circuit for transmitting image data to an external display 4 under control of the CPU 301. The external device connection I/F 318 is an interface circuit that connects the videoconference terminal 3 to various external devices. The near-distance communication circuit 319 is a communication circuit that communicates in compliance with the NFC (registered trademark), the Bluetooth (registered trademark) and the like.

The bus line 310 may be an address bus or a data bus, which electrically connects various elements such as the CPU 301 illustrated in FIG. 10.

The display 4 is an example of a display unit, such as a liquid crystal or organic electroluminescence (EL) display that displays an image of a subject, an operation icon, or the like. The display 4 is connected to the display I/F 317 by a cable 4c. The cable 4c may be an analog red green blue (RGB) (video graphic array (VGA)) signal cable, a component video cable, a high-definition multimedia interface (HDMI) (registered trademark) signal cable, or a digital video interactive (DVI) signal cable.

The camera 312 includes a lens and a solid-state imaging element that converts an image (video) of a subject to electronic data through photoelectric conversion. As the solid-state imaging element, for example, a CMOS sensor or a CCD sensor is used. The external device connection I/F 318 is capable of connecting an external device such as an external camera, an external microphone, or an external speaker through a USB cable or the like. In a case in which an external camera is connected, the external camera is driven in preference to the built-in camera 312 under control of the CPU 301. Similarly, in a case in which an external microphone is connected or an external speaker is connected, the external microphone or the external speaker is driven in preference to the built-in microphone 314 or the built-in speaker 315 under control of the CPU 301.

The recording medium 306 is removable from the videoconference terminal 3. In addition to the flash memory 304, any suitable nonvolatile memory, such as an electrically erasable and programmable ROM (EEPROM), may be used, provided that it reads or writes data under control of CPU 301.

### <Hardware Configuration of Communication Management System 5 and PC 7>

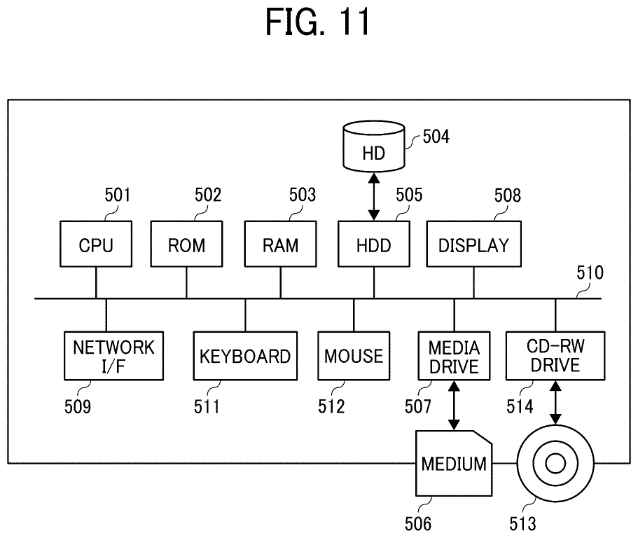

Hereinafter, a description is given of hardware configurations of the communication management system 5 and the PC 7, with reference to FIG. 11. FIG. 11 is a block diagram illustrating a hardware configuration of any one of the communication management system 5 and the PC 7. In this disclosure, both the communication management system 5 and the PC 7 are implemented by a computer. Therefore, a description is given of a configuration of the communication management system 5, and the description of a configuration of the PC 7 is omitted, having the same or substantially the same configuration as that of the communication management system 5.

The communication management system 5 includes a CPU 501, a ROM 502, a RAM 503, an HD 504, a hard disc drive (HDD) 505, a media drive 507, a display 508, a network I/F 509, a keyboard 511, a mouse 512, a compact disc rewritable (CD-RW) drive 514, and a bus line 510. The CPU 501 is circuitry that controls entire operation of the communication management system 5. The ROM 502 stores programs such as an IPL to boot the CPU 501. The RAM 503 is used as a work area for the CPU 501. The HD 504 stores various data such as programs for the communication management system 5. The HDD 505 controls reading and writing of data from and to the HD 504 under control of the CPU 501. The media drive 507 controls reading and writing (storing) of data from and to a recording medium 506 such as a flash memory. The display 508 displays various information such as a cursor, menus, windows, characters, or images. The network I/F 509 enables communication of data with an external device through the communication network 100. The keyboard 511 includes a plurality of keys to allow a user to input characters, numbers, and various instructions. The mouse 512 allows a user to input an instruction for selecting and executing various functions, selecting an item to be processed, or moving the cursor. The CD-RW drive 514 controls reading and writing of data from and to a CD-RW 513 as an example of a removable recording medium. The bus line 510 electrically connects those parts or devices of the communication management system 5 to each other as illustrated in FIG. 11. Examples of the bus line 510 include an address bus and a data bus.

### <Hardware Configuration of Smartphone 9>

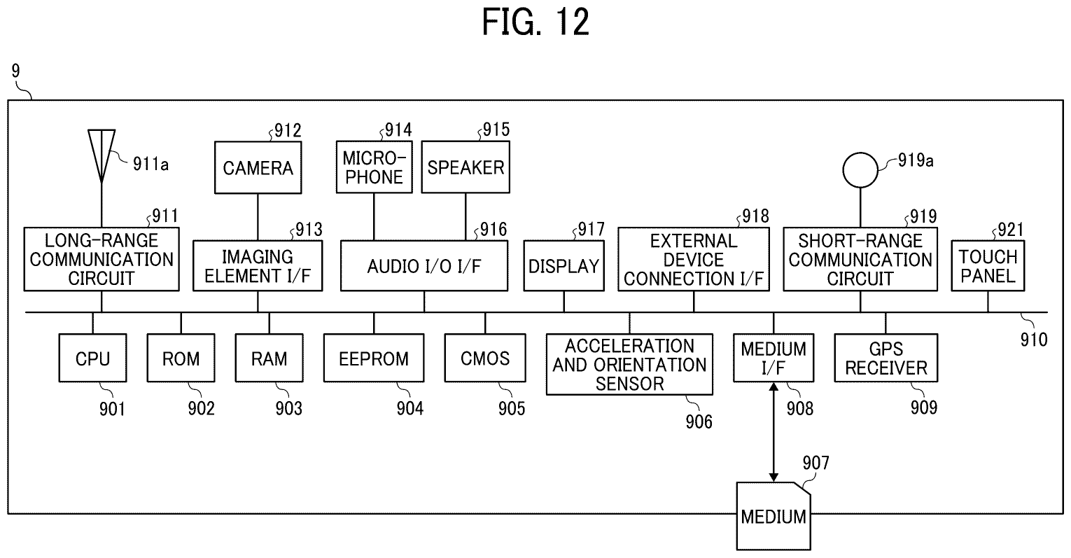

Hereinafter, a description is given of hardware of the smartphone 9 with reference to FIG. 12. FIG. 12 is a block diagram illustrating a hardware configuration of the smartphone 9. As illustrated in FIG. 12, the smartphone 9 includes a CPU 901, a ROM 902, a RAM 903, an EEPROM 904, a CMOS sensor 905, an acceleration and orientation sensor 906, a medium I/F 908, and a global positioning system (GPS) receiver 909.

The CPU 901 is circuitry that controls an entire operation of the smartphone 9. The ROM 902 stores programs such as an IPL to boot the CPU 901. The RAM 903 is used as a work area for the CPU 901. The EEPROM 904 reads or writes various data such as a control program for the smartphone 9 under control of the CPU 901. The CMOS sensor 905 captures an object (mainly, a user operating the smartphone 9) under control of the CPU 901 to obtain image data. The acceleration and orientation sensor 906 includes various sensors such as an electromagnetic compass for detecting geomagnetism, a gyrocompass, or an acceleration sensor. The medium I/F 908 controls reading or writing of data with respect to a recording medium 907 such as a flash memory. The GPS receiver 909 receives a GPS signal from a GPS satellite.

The smartphone 9 further includes a long-range communication circuit 911, a camera 912, an imaging element I/F 913, a microphone 914, a speaker 915, an audio input/output interface 916, a display 917, an external device connection I/F 918, a short-range communication circuit 919, an antenna 919a for the short-range communication circuit 919, and a touch panel 921.

The long-range communication circuit 911 is a circuit that communicates with other device through the communication network 100. The camera 912 is an example of a built-in imaging device capable of capturing a subject under control of the CPU 901 to obtain image data. The imaging element I/F 913 is a circuit that controls driving of the camera 912. The microphone 914 is an example of a built-in audio collecting device capable of inputting audio. The audio input/output interface 916 is a circuit for controlling input and output of audio signals between the microphone 914 and the speaker 915 under control of the CPU 901. The display 917 is an example of a display unit, such as a liquid crystal or organic electroluminescence (EL) display that displays an image of a subject, an operation icon, or the like. The external device connection I/F 918 is an interface circuit that connects the smartphone 9 to various external devices. The short-range communication circuit 919 is a communication circuit that communicates in compliance with the NFC, the Bluetooth and the like. The touch panel 921 is an example of an input device to operate a smartphone 9 by touching a screen of the display 917.

The smartphone 9 further includes a bus line 910. Examples of the bus line 910 include an address bus and a data bus, which electrically connects the elements such as the CPU 901.

It should be noted that a recording medium such as a CD-ROM or a hard disk storing any one of the above-described programs may be distributed domestically or overseas as a program product.

### <Functional Configuration According to Embodiment>

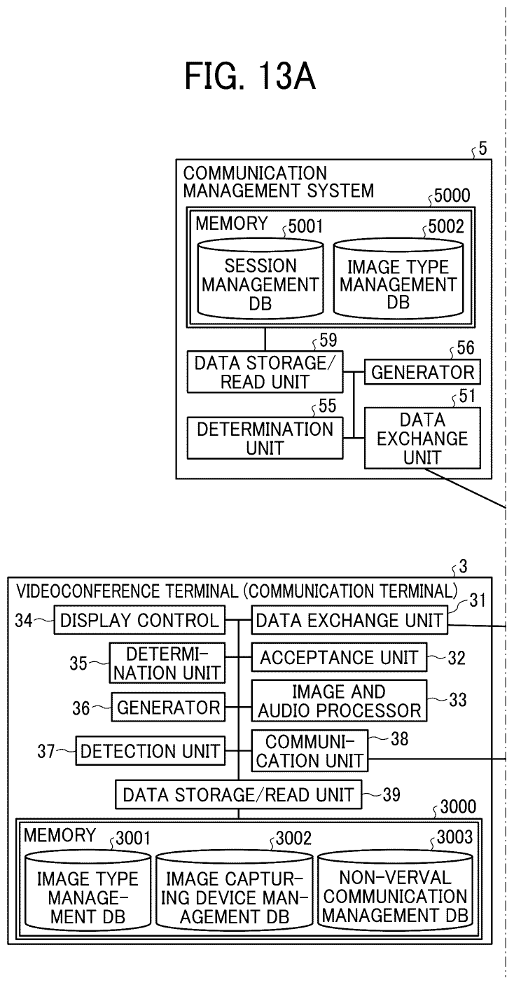

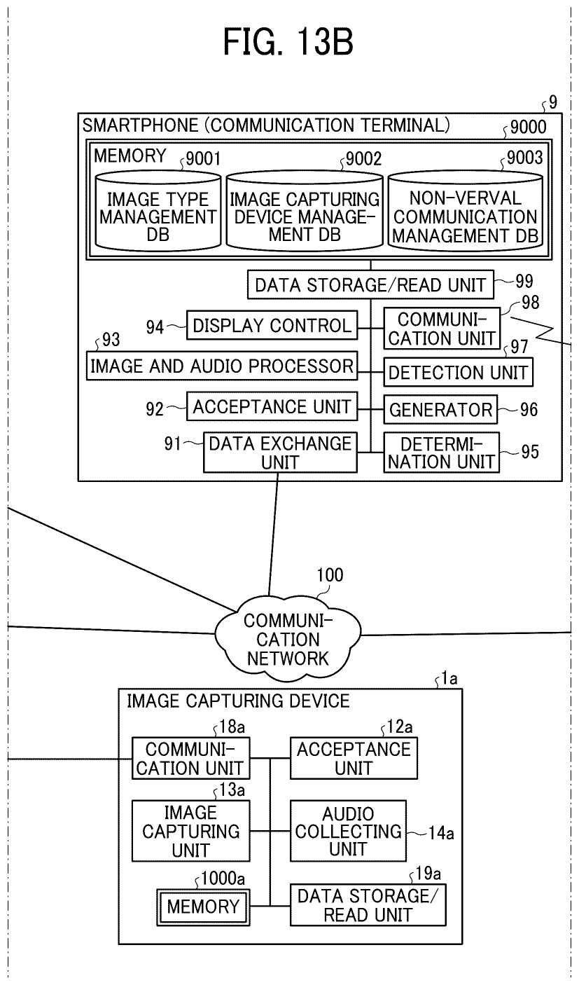

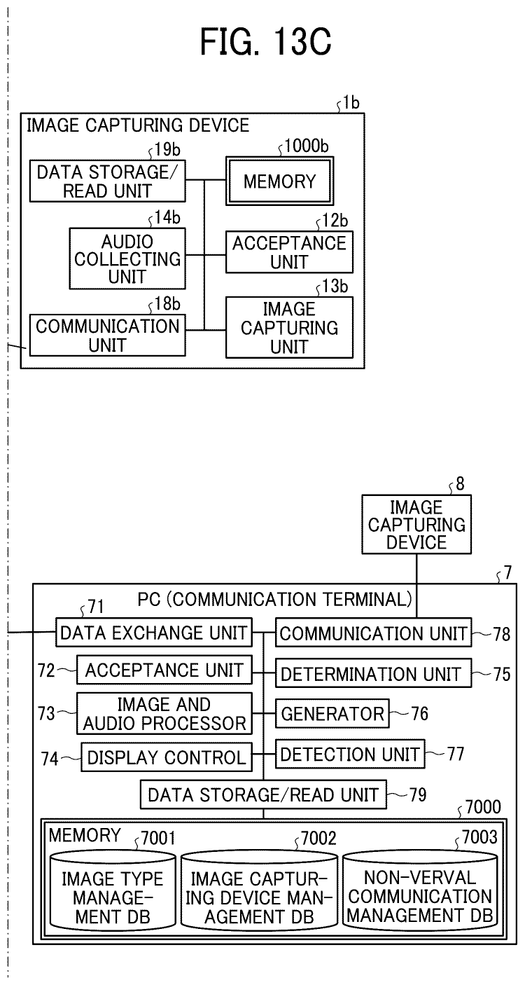

Hereinafter, a description is given of a functional configuration of the image communication system according to this embodiment, with reference to FIG. 13 to FIG. 18. FIGS. 13A-13C are functional block diagrams of the image capturing devices 1a and 1b, the videoconference terminal 3, the communication management system 5, the PC 7, and the smartphone 9, which constitute a part of the image communication system of this embodiment.

<Functional Configuration of Image Capturing Device 1a>

As illustrated in FIGS. 13A-13C, the image capturing device 1a includes an acceptance unit 12a, an image capturing unit 13a, an audio collecting unit 14a, a communication unit 18a, and a data storage/read unit 19a. These units are functions or means that are implemented by or that are caused to function by operating any of the elements illustrated in FIG. 9 in cooperation with the instructions of the CPU 111 according to the image capturing device control program expanded from the SRAM 113 to the DRAM 114.

The image capturing device 1a further includes a memory 1000a, which is implemented by the ROM 112, the SRAM 113, and the DRAM 114 illustrated in FIG. 9. The memory 1000a stores therein a globally unique identifier (GUID) identifying the own device (i.e., the image capturing device 1a).

### (Each Functional Unit of Image Capturing Device 1a)

Hereinafter, referring to FIG. 9 and FIGS. 13A-13C, a further detailed description is given of each functional unit of the image capturing device 1a according to the embodiment.

The acceptance unit 12a of the image capturing device 1a is implemented by the operation unit 115 illustrated in FIG. 9, when operating under control of the CPU 111. The acceptance unit 12a receives an instruction input from the operation unit 115 according to a user operation.

The image capturing unit 13a is implemented by the imaging unit 101, the image processing unit 104, and the imaging control unit 105, illustrated in FIG. 9, when operating under control of the CPU 111. The image capturing unit 13a captures an image of a subject or surroundings to obtain captured-image data.

The audio collecting unit 14a is implemented by the microphone 108 and the audio processing unit 109 illustrated in FIG. 9, when operating under control of the CPU 111. The audio collecting unit 14a collects sounds around the image capturing device 1a.

The communication unit 18a, which is implemented by instructions of the CPU 111, communicates data with a communication unit 38 of the videoconference terminal 3 using the near-distance wireless communication technology in compliance with such as NFC, Bluetooth, or Wi-Fi.

The data storage/read unit 19a, which is implemented by instructions of the CPU 111 illustrated in FIG. 9, stores data or information in the memory 1000a or reads out data or information from the memory 1000a.

### (Each Functional Unit of Image Capturing Device 1b)

The image capturing device 1b includes an acceptance unit 12b, an image capturing unit 13b, an audio collecting unit 14b, a communication unit 18b, a data storage/read unit 19b, and a memory 1000b. These functional units of the image capturing device 1b implement the similar or substantially the similar functions as those of the acceptance unit 12a, the image capturing unit 13a, the audio collecting unit 14a, the communication unit 18a, the data storage/read unit 19a, and the memory 1000 of the image capturing device 1a, respectively. Therefore, redundant descriptions thereof are omitted below. The image capturing device 1 also has a storage unit 1000b constructed by a ROM 112, an SRAM 113, and a DRAM 114 shown in FIG. 9. The memory 1000b stores the GUID of the photographing device itself.

### <Functional Configuration of Videoconference Terminal 3>

As illustrated in FIGS. 13A-13C, the videoconference terminal 3 includes a data exchange unit 31, an acceptance unit 32, an image and audio processor 33, a display control 34, a determination unit 35, a generator 36, a detection unit 37, a communication unit 38, and a data storage/read unit 39. These units are functions that are implemented by or that are caused to function by operating any of the elements illustrated in FIG. 10 in cooperation with the instructions of the CPU 301 according to the control program for the videoconference terminal 3, expanded from the flash memory 304 to the RAM 303.

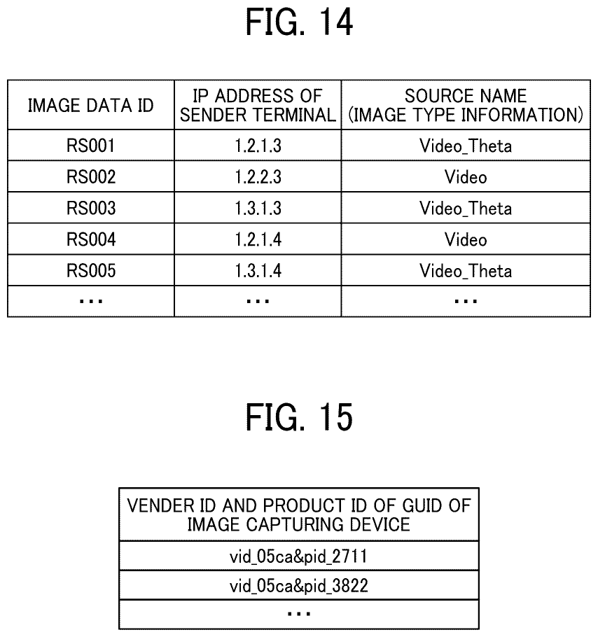

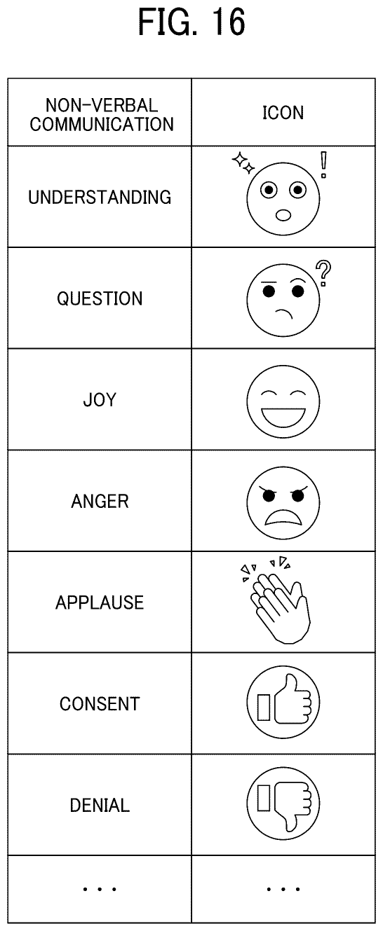

The videoconference terminal 3 further includes a memory 3000, which is implemented by the ROM 302, the RAM 303, and the flash memory 304 illustrated in FIG. 10. The memory 3000 stores an image type management DB 3001, an image capturing device management DB 3002, and a non-verbal communication management DB 3003. Among these DBs, the image type management DB 3001 is implemented by an image type management table illustrated in FIG. 14. The image capturing device management DB 3002 is implemented by an image capturing device management table illustrated in FIG. 15. The non-verbal communication management DB 3003 is implemented by a non-verbal communication management table illustrated in FIG. 16.

### (Image Type Management Table)

FIG. 14 is a conceptual diagram illustrating the image type management table according to an embodiment of this disclosure. The image type management table stores an image data identifier (ID), an IP address, which is an example of an address of a sender terminal and a source name, in association with one another. The image data ID is one example of image data identification information for identifying image data to be used in video communication. An identical image data ID is assigned to image data transmitted from the same sender terminal. Accordingly, a destination terminal (that is, a communication terminal that receives image data) can identify a sender terminal from which the image data is received. The IP address of the sender terminal, which is associated with specific image data ID, is an IP address of a communication terminal that transmits image data identified by that image data ID associated with the IP address. The source name, which is associated with specific image data ID, is a name for identifying an image capturing device that outputs the image data identified by that image data ID associated with the source name. The source name is one example of image type information. This source name is generated by a communication terminal such as the videoconference terminal 3 according to a predetermined naming rule.

The example of the image type management table illustrated in FIG. 14 indicates that four communication terminals, whose IP addresses are respectively “1.2.1.3”, “1.2.2.3”, “1.3.1.3”, and “1.3.2.3” transmit image data identified by the image data ID “RS001”, “RS002”, “RS003”, and “RS004”, respectively. Further, according to the image type management table illustrated in FIG. 15, the image types represented by the source names of those four communication terminals are “Video_Theta”, “Video_Theta”, “Video”, and “Video”, which indicate that the image types are the special image, special image, general image, and general image, respectively. In this disclosure, the special image is a full spherical image, and the general image is a planar image.

In another example, information regarding data other than the image data may be stored in the image type management table in association with the image data ID. Examples of the data other than the image data include audio data and presentation material data shared on a screen, for example, in video communication in which the image is shared.

### (Image Capturing Device Management Table)

FIG. 15 is a conceptual diagram illustrating the image capturing device management table according to an embodiment of this disclosure. The image capturing device management table stores a vendor ID and a product ID from among the GUIDs of an image capturing device that is capable of obtaining two hemispherical images, from which a full spherical image is generated. As the GUID, a combination of a vendor ID (VID) and a product ID (PID) used in a USB device is used, for example. Those vendor ID and product ID are stored in a communication terminal such as a videoconference terminal before shipment. In another example, those IDs are added and stored in the videoconference terminal after shipment.

### (Non-Verbal Communication Management Table)

FIG. 16 is a conceptual diagram showing a non-verbal communication management table. In this non-verbal communication management table, the content of a person's non-verbal communication is stored and managed in association with an icon representing the content of this non-verbal communication. “Non-verbal communication” refers to communication that does not rely on language, and in this embodiment, with respect to a person, includes at least one of facial expression, complexion, gaze, gestures, hand movements, and body posture.

### (Each Functional Unit of Videoconference Terminal 3)

Hereinafter, referring to FIG. 10 and FIGS. 13A-13C, a further detailed description is given of each functional unit of the videoconference terminal 3.

The data exchange unit 31 of the videoconference terminal 3 is implemented by the network I/F 311 illustrated in FIG. 10, when operating under control of the CPU 301. The data exchange unit 31 exchanges data or information with communication management system 5 via the communication network 100.

The acceptance unit 32 is implemented by the operation key 308, when operating under control of the CPU 301. The acceptance unit 32 receives selections or inputs from a user. An input device such as a touch panel may be used as an alternative to or in place of the operation key 308.

The image and audio processor 33, which is implemented by instructions of the CPU 301 illustrated in FIG. 10, processes image data that is obtained by capturing a subject by the camera 312. In addition, after the audio of the user is converted to an audio signal by the microphone 314, the image and audio processor 33 processes audio data according to this audio signal.

Further, the image and audio processor 33 processes image data received from other communication terminal based on the image type information such as the source name, to enable the display control 34 to control the display 4 to display an image based on the processed image data. More specifically, when the image type information indicates a special image, the image and audio processor 33 converts the image data such as hemispherical image data as illustrated in FIGS. 3A and 3B into full spherical image data to generate full spherical image data as illustrated in FIG. 4B, and further generates a predetermined-area image as illustrated in FIG. 6B. Furthermore, the image and audio processor 33 outputs, to the speaker 315, an audio signal according to audio data that is received from the other communication terminal via the communication management system 5. The speaker 315 outputs audio based on the audio signal.

The display control 34 is implemented by the display I/F 317, when operating under control of the CPU 301. The display control 34a controls the display 4 to display images or characters.

The determination unit 35, which is implemented by instructions of the CPU 301, determines an image type according to the image data received from such as the image capturing device 1a.

The generator 36 is implemented by instructions of the CPU 301. The generator 36 generates a source name, which is one example of the image type information, according to the above-described naming rule, based on a determination result generated by the determination unit 35 indicating a general image or a special image (that is, full spherical image in this disclosure). For example, when the determination unit 35 determines the image type as a general image, the generator 36a generates the source name “Video” indicating a general image. By contrast, when the determination unit 35 determines the image type as a special image, the generator 36a generates the source name “Video_Theta” indicating a special image.

The detection unit 37 uses a trained machine learning model to search for and detect non-verbal communication by a person in an image. The detection unit 37 detects when the non-verbal communication is included in an area in the spherical image. In an exemplary implementation, the detection unit 37 detects when the non-verbal communication is made by one or more people outside of a predetermined area in the spherical image. In another exemplary implementation, detection unit 37 is trained by a machine learning model to detect non-verbal communication by one or more people in an area outside of the predetermined area in a spherical image.

In an exemplary implementation, use of or training by the machine learning model allows for searching for a person in the spherical image. Examples of the machine learning model may be found in References 1-3 below, which are incorporated by reference. For example, determination of a kind of expression the person has (e.g., wondering) is shown in Reference 2. Furthermore, determination of a kind of movement the person has (e.g., clapping) is shown in Reference 3. When detecting a movement such as clapping, the detection unit 37 may recognize it from a video of a certain time including image data (frame data) before and after.
<Reference 1> YOLO (https://docs.ultralytics.com/)
<Reference 2> deepface (https://github.com/serengil/deepface)
<Reference 3> PoseNet (https://www.tensorflow.org/lite/examples/pose_estimation/overview?hl=ja)

The communication unit 38 is implemented by the near-distance communication circuit 319 and the antenna 319a, when operating under control of the CPU 301. The communication unit 38 communicates with the communication unit 18 of the image capturing device 1a using the near-distance communication technology in compliance with such as NFC, Bluetooth, or Wi-Fi. Although in the above description the communication unit 38 and the data exchange unit 31 have separate communication units, alternatively a shared communication unit may be used.

The data storage/read unit 39, which is implemented by instructions of the CPU 301 illustrated in FIG. 10, stores data or information in the memory 3000 or reads out data or information from the memory 3000.

### <Functional Configuration of Communication Management System 5>

Hereinafter, referring to FIG. 11 and FIG. 14, a detailed description is given of each functional unit of the communication management system 5. The communication management system 5 includes a data exchange unit 51, a determination unit 55, a generator 56, and a data storage/read unit 59. These units are functions that are implemented by or that are caused to function by operating any of the elements illustrated in FIG. 11 in cooperation with the instructions of the CPU 501 according to the control program for the communication management system 5, expanded from the HD 504 to the RAM 503.

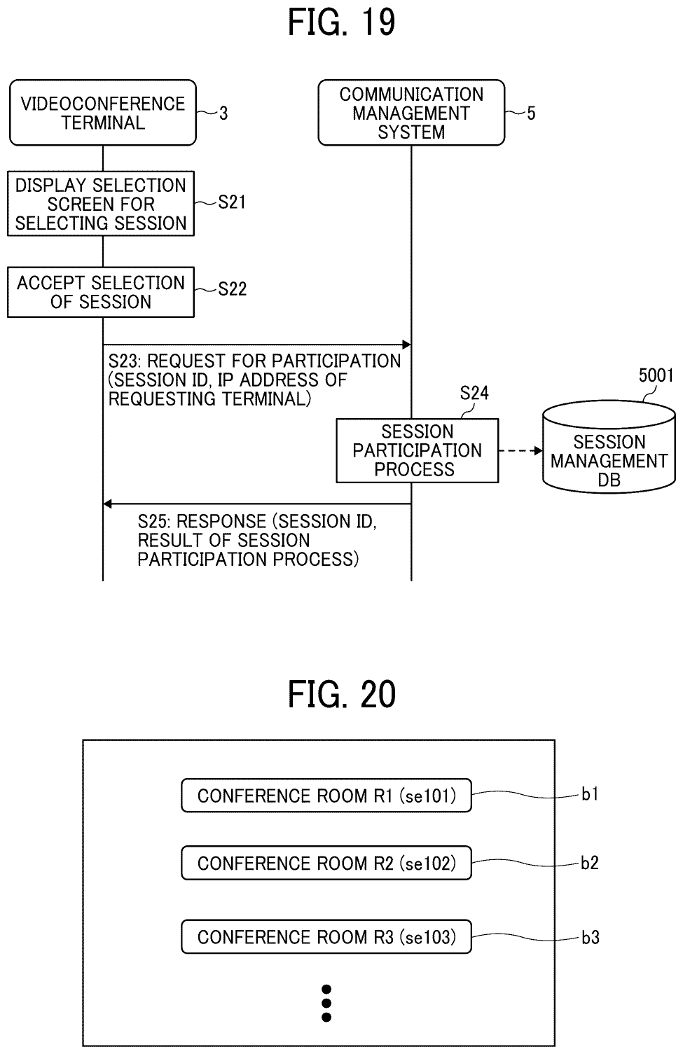

The communication management system 5 further includes a memory 5000, which is implemented by the RAM 503 and the HD 504 illustrated in FIG. 11. The memory 5000 stores a session management DB 5001, an image type management DB 5002. The session management DB 5001 is implemented by a session management table illustrated in FIG. 19. The image type management DB 5002 is implemented by an image type management table illustrated in FIG. 20.

### (Session Management Table)

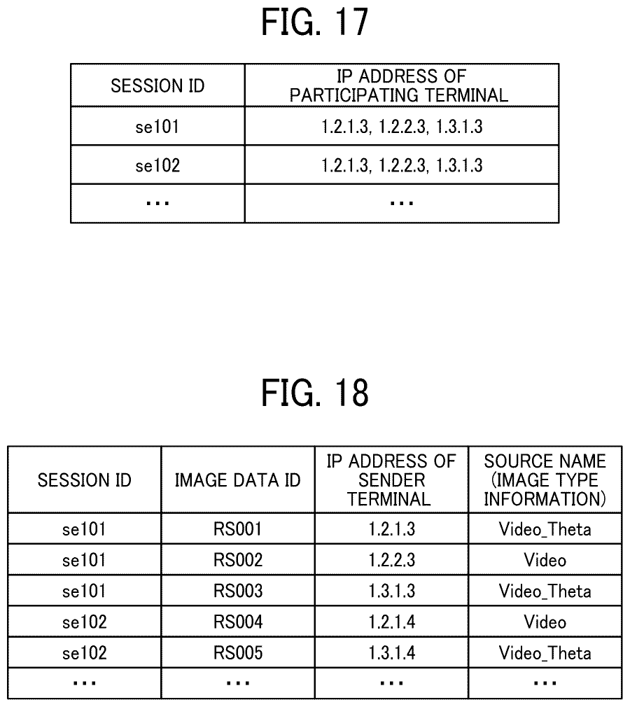

FIG. 17 is a conceptual diagram illustrating the session management table according to an embodiment of this disclosure. The session management table stores a session ID and an IP address of participating communication terminal, in association with each other. The session ID is one example of session identification information for identifying a session that implements video calling. The session ID is generated for each virtual conference room. The session ID is also stored in each communication terminal such as the videoconference terminal 3. Each communication terminal selects a desired session ID from the session ID or IDs stored therein. The IP address of participating communication terminal indicates an IP address of the communication terminal participating in a virtual conference room identified by the associated session ID. The virtual conference room may be utilized to initiate a conference or meeting, or another communication event, communication activity or occurrence between participants in the virtual conference session.

### (Image Type Management Table)

FIG. 18 is a conceptual diagram illustrating the image type management table according to an embodiment of this disclosure. The image type management table illustrated in FIG. 20 stores, in addition to the information items stored in the image type management table illustrated in FIG. 15, the same session ID as the session ID stored in the session management table, in association with one another. The example of the image type management table illustrated in FIG. 20 indicates that three communication terminals whose IP addresses are respectively “1.2.1.3”, “1.2.2.3”, and “1.3.1.3” are participating in the virtual conference room identified by the session ID “se101”. The communication management system 5 stores the same image data ID, IP address of the sender terminal, and image type information as those stored in a communication terminal such as the videoconference terminal 3 in order to transmit such information as the image type information to both a communication terminal that is already in video calling and a newly participating communication terminal that enters the virtual conference room after the video calling has started. Accordingly, the communication terminal that is already in the video calling and the newly participating communication terminal do not have to exchange such information as the image type information with each other.

### (Each Functional Unit of Communication Management System 5)

Hereinafter, referring to FIG. 11 and FIGS. 13A-13C, a detailed description is given of each functional unit of the communication management system 5.

The data exchange unit 51 of the communication management system 5 is implemented by the network I/F 509 illustrated in FIG. 11, when operating under control of the CPU 501. The data exchange unit 51 exchanges data or information with the videoconference terminal 3, or the PC 7 via the communication network 100.

The determination unit 55, which is implemented by instructions of the CPU 501, performs various determinations.

The generator 56, which is implemented by instructions of the CPU 501, generates the image data ID.

The data storage/read unit 59 is implemented by the HDD 505 illustrated in FIG. 11, when operating under control of the CPU 501. The data storage/read unit 59 stores data or information in the memory 5000 or reads out data or information from the memory 5000.

### <Functional Configuration of PC 7>

Hereinafter, referring to FIG. 11 and FIGS. 13A-13C, a detailed description is given of a functional configuration of the PC 7. The PC 7 has the same or substantially the same functions as those of the videoconference terminal 3. In other words, as illustrated in FIGS. 13A-13C, the PC 7 includes a data exchange unit 71, an acceptance unit 72, an image and audio processor 73, a display control 74, a determination unit 75, a generator 76, a detection unit 77, a communication unit 78, and a data storage/read unit 79. These units are functions that are implemented by or that are caused to function by operating any of the hardware elements illustrated in FIG. 11 in cooperation with the instructions of the CPU 501 according to the control program for the PC 7, expanded from the HD 504 to the RAM 503.

The PC 7 further includes a memory 7000, which is implemented by the ROM 502, the RAM 503 and the HD 504 illustrated in FIG. 11. The memory 7000 stores an image type management DB 7001, an image capturing device management DB 7002, a non-verbal communication management DB 7003. These DBs 7001, 7002, and 7003 have the same or the substantially the same data structure as the image type management DB 3001, the image capturing device management DB 3002, and the non-verbal communication management DB 3003 of the videoconference terminal 3, respectively. Therefore, redundant descriptions thereof are omitted below.

### (Each Functional Unit of PC 7)

The data exchange unit 71 of the PC 7, which is implemented by the network I/F 509, when operating under control of the CPU 501 illustrated in FIG. 11, implements the similar or substantially the similar function to that of the data exchange unit 31a.

The acceptance unit 72, which is implemented by the keyboard 511 and the mouse 512, when operating under control of the CPU 501, implements the similar or substantially the similar function to that of the acceptance unit 32. The image and audio processor 73, which is implemented by instructions of the CPU 501, implements the similar or substantially the similar function to that of the image and audio processor 33. The display control 74, which is implemented by instructions of the CPU 501, implements the similar or substantially the similar function to that of the display control 34. The determination unit 75, which is implemented by instructions of the CPU 501, implements the similar or substantially the similar function to that of the determination unit 35. The generator 76, which is implemented by instructions of the CPU 501, implements the similar or substantially the similar function to that of the generator 36. The detection unit 77, which is implemented by instructions of the CPU 501, implements the similar or substantially the similar function to that of the detection unit 37. The communication unit 78, which is implemented by instructions of the CPU 501, implements the similar or substantially the similar function to that of the communication unit 38. The data storage/read unit 79, which is implemented by instructions of the CPU 501, stores data or information in the memory 7000 or reads out data or information from the memory 7000.

### <Functional Configuration of Smartphone 9>

Hereinafter, referring to FIG. 12 and FIGS. 13A-13C, a detailed description is given of a functional configuration of the smartphone 9. The smartphone 9 has the same or substantially the same functions as those of the videoconference terminal 3. In other words, as illustrated in FIGS. 13A-13C, the smartphone 9 includes a data exchange unit 91, an acceptance unit 92, an image and audio processor 93, a display control 94, a determination unit 95, a generator 96, a detection unit 97, a communication unit 98, and a data storage/read unit 99. These units are functions that are implemented by or that are caused to function by operating any of the hardware elements illustrated in FIG. 12 in cooperation with the instructions of the CPU 901 according to the control program for the smartphone 9 expanded from the EEPROM 904 to the RAM 903.

The smartphone 9 further includes a memory 9000, which is implemented by the ROM 902, the RAM 903, and the EEPROM 904 illustrated in FIG. 12. The memory 9000 stores an image type management DB 9001, an image capturing device management DB 9002, and a non-verbal communication management DB 9003. These DBs 9001, 9002, and 9003 have the same or the substantially the same data structure as the image type management DB 3001, the image capturing device management DB 3002, and non-verbal communication management DB 3003 of the videoconference terminal 3, respectively. Therefore, redundant descriptions thereof are omitted below.

### (Each Functional Unit of Smartphone 9)

The data exchange unit 91 of the smartphone 9, which is implemented by the long-range communication circuit 911 illustrated in the FIG. 12, when operating under control of the CPU 901, implements the similar or substantially the similar function to that of the data exchange unit 31.

The acceptance unit 92, which is implemented by the touch panel 921, when operating under control of the CPU 901, implements the similar or substantially the similar function to that of the acceptance unit 32.

The image and audio processor 93, which is implemented by instructions of the CPU 901, implements the similar or substantially the similar function to that of the image and audio processor 33.

The display control 94, which is implemented by instructions of the CPU 901, implements the similar or substantially the similar function to that of the display control 34.

The determination unit 95, which is implemented by instructions of the CPU 901, implements the similar or substantially the similar function to that of the determination unit 35.

The generator 96, which is implemented by instructions of the CPU 901, implements the similar or substantially the similar function to that of the generator 36.

The detection unit 97, which is implemented by instructions of the CPU 901, implements the similar or substantially the similar function to that of the detection unit 37.

The communication unit 98, which is implemented by instructions of the CPU 901, implements the similar or substantially the similar function to that of the communication unit 38a.

The data storage/read unit 99, which is implemented by instructions of the CPU 901, stores data or information in the memory 9000 or reads out data or information from the memory 9000.

### <Operation>

### <Participation Process>

Referring to FIG. 19 to FIG. 23, a description is given hereinafter of operation according to the present embodiment. Firstly, a process of participating in a specific communication session is described with reference to FIG. 19 and FIG. 20. FIG. 19 is a sequence diagram illustrating an operation of participating in the specific communication session. FIG. 20 is a view illustrating a selection screen for accepting selection of a desired communication session (virtual conference). As discussed above, the virtual conference may be a conference or meeting, or another communication event, communication activity or occurrence between participants in the virtual conference.

First, the acceptance unit 32 of the videoconference terminal 3 accepts an instruction to display the selection screen for the communication session (virtual conference room), which is input by a user (e.g., the user A1) at the site A. Then, the display control 34a controls the display 4a to display the selection screen as illustrated in FIG. 20 (S21). The selection screen displays selection buttons b1, b2, and b3, which respectively represent virtual conference rooms R1, R2, R3, each being a selection target. Each of the selection buttons b1, b2, and b3 is associated with the session ID.

When the user A1 selects a desired selection button (in this example, the selection button b1) on the selection screen, the acceptance unit 32a accepts selection of a communication session (S22). Then, the data exchange unit 31a transmits a request for participating in a virtual conference room to the communication management system 5 (S23). This participation request includes the session ID identifying the communication session for which the selection is accepted at S22, and the IP address of the videoconference terminal 3 as a request sender terminal. The communication management system 5 receives the participation request at the data exchange unit 51.

Next, the data storage/read unit 99 performs a process for enabling the videoconference terminal 3 to participate in the communication session (S24). More specifically, in the session management DB 5001 (FIG. 19), the data storage/read unit 99 adds the IP address that is received at S23 to a field of the participating terminal IP address in a record of the same session ID as the session ID that is received at S23. The data exchange unit 51 transmits a response to the participation request to the videoconference terminal 3 (S25). This response to the participation request includes the session ID that is received at S23, and a result of the participation process. The videoconference terminal 3 receives the response to the participation request at the data exchange unit 31. The following describes a case in which the process for enabling the videoconference terminal 3 to participate in the communication session is successfully completed.

### <Management Process of Image Type Information>

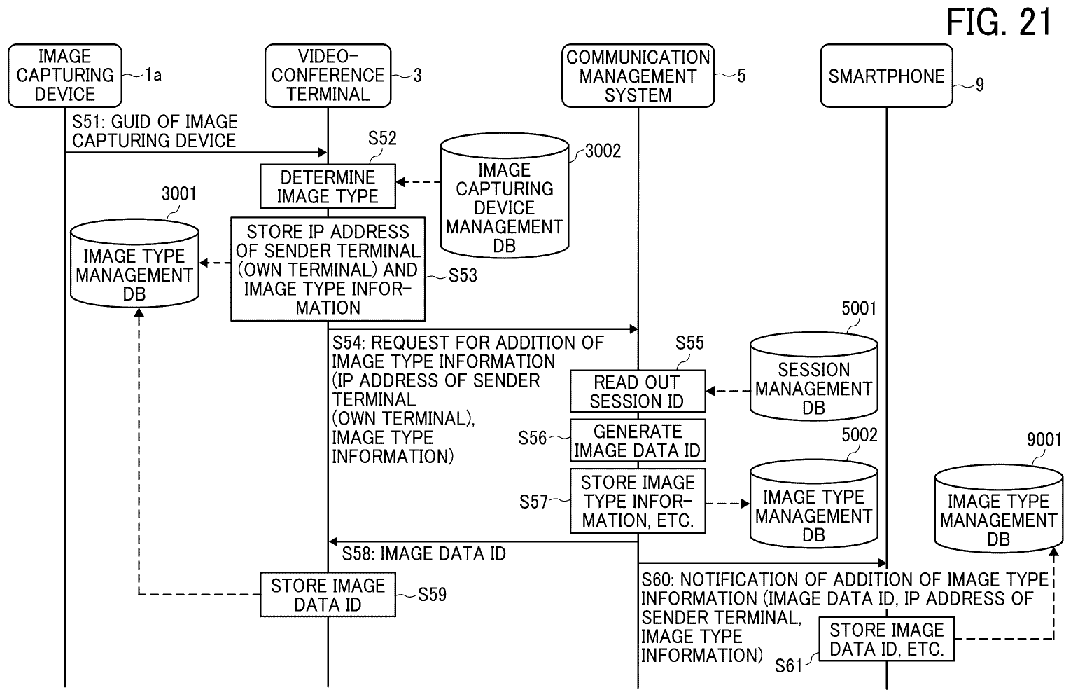

Hereinafter, referring to FIG. 21, a description is given of a management process of the image type information. FIG. 21 is a sequence diagram illustrating an operation of managing the image type information.

First, when a user (e.g., the user A1) at the site A connects the cradle 2a, on which the image capturing device 1a is mounted, to the videoconference terminal 3, using the wired cable such as a USB cable, the data storage/read unit 19a of the image capturing device 1a reads out the GUID of the own device (e.g., the image capturing device 1a) from the memory 1000a. Then, the communication unit 18a transmits the own device's GUID to the communication unit 38a of the videoconference terminal 3 (S51). The videoconference terminal 3 receives the GUID of the image capturing device 1a at the communication unit 38.

Next, the determination unit 35 of the videoconference terminal 3 determines whether the same vendor ID and product ID as those of the GUID received at S51 are stored in the image capturing device management DB 3002 (FIG. 15) to determine the image type (S52). More specifically, the determination unit 35 determines that the image capturing device 1a is an image capturing device that captures a special image (a full spherical image, in this disclosure), based on determination that the same vender ID and product ID are stored in the image capturing device management DB 3002. By contrast, the determination unit 35 determines that the image capturing device 1a is an image capturing device that captures a general image, based on determination that the same vender ID and product ID are not stored in the image capturing device management DB 3002.

Next, the data storage/read unit 39 stores, in the image type management DB 3001a (FIG. 14), the IP address of the own terminal (i.e., videoconference terminal 3) as the sender terminal in association with the image type information, which is a determination result determined at S52 (S53). In this state, the image data ID is not yet associated. Examples of the image type information include the source name that is determined according to a predetermined naming rule, and the image type (general image or special image type).

Then, the data exchange unit 31 transmits a request for adding the image type information to the communication management system 5 (S54). This request for adding image type information includes the IP address of the own terminal as a sender terminal, and the image type information, both being stored at S53 in association with each other. The communication management system 5 receives the request for adding the image type information at the data exchange unit 51.

Next, the data storage/read unit 59 of the communication management system 5 searches the session management DB 5001 (FIG. 17) using the IP address of the sender terminal received at S54 as a search key, to read out the session ID associated with the IP address (S55).

Next, the generator 56 generates a unique image data ID (S56). Then, the data storage/read unit 59 stores, in the image type management DB 5002 (FIG. 20), a new record associating the session ID that is read out at S55, the image data ID generated at S56, the IP address of the sender terminal and the image type information that are received at S54, with one another (S57). The data exchange unit 51 transmits the image data ID generated at S56 to the videoconference terminal 3 (S58). The videoconference terminal 3 receives the image data ID at the data exchange unit 31.

Next, the data storage/read unit 39 of the videoconference terminal 3 stores, in the image type management DB 3001a (FIG. 14), the image data ID received at S58, in association with the IP address of the own terminal (i.e., videoconference terminal 3) as the sender terminal and the image type information that are stored at S53 (S59).

Further, the data exchange unit 51 of the communication management system 5 transmits a notification of addition of the image type information to other communication terminal (the smartphone 9, in this example) (S60). This notification of addition of the image type information includes the image data ID generated at S56, and the IP address of the own terminal (i.e., videoconference terminal 3) as the sender terminal and the image type information that are stored at S53. The smartphone 9 receives the notification of addition of the image type information at the data exchange unit 91. The destination to which the data exchange unit 51 transmits the notification is other IP address that is associated with the same session ID as that associated with the IP address of the videoconference terminal 3 in the session management DB 5001 (FIG. 17). In other words, the destination is other communication terminal that is in the same virtual conference room as the videoconference terminal 3.

Next, the data storage/read unit 99 of the smartphone stores, in the image type management DB 9001 (FIG. 14), a new record associating the image data ID, the IP address of the sender terminal, and the image type information, which are received at S60 (S61). In substantially the same manner, the notification of addition of the image type information is transmitted to the PC 7, each being other communication terminal. The PC 7 each stores the image data ID, the IP address of the sender terminal, and the image type information, in corresponding one of the image type management DB 7001. Through the operation as described heretofore, the same information is shared among the communication terminals in the image type management DBs 3001, 7001 and 9001, respectively.

<Image Data Transmission Process>

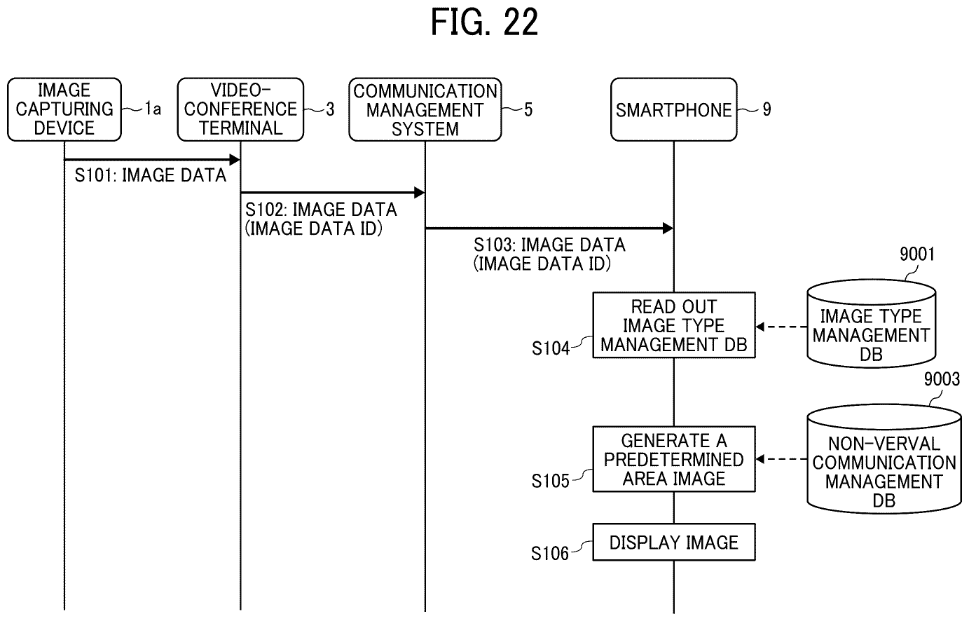

Hereinafter, referring to FIGS. 22 to 30, a description is given of an image data transmission process in video calling. FIG. 22 is a sequence diagram illustrating an image data transmission process in video calling.

First, the communication unit 18a of the image capturing device 1a transmits image data and audio data obtained by capturing a subject or surroundings to the communication unit 38 of the videoconference terminal 3 (S101). In this case, because the image capturing device 1a is a device that is capable of obtaining two hemispherical images from which a full spherical image is generated, the image data is configured by data of the two hemispherical images as illustrated in FIGS. 3A and 3B. The videoconference terminal 3 receives the image data at the communication unit 38.

Next, the data exchange unit 31 of the videoconference terminal 3 transmits, to the communication management system 5, the image data and the audio data received from the image capturing device 1a (S102). This transmission includes an image data ID for identifying the image data as a transmission target. Thus, the communication management system 5 receives the image data and the image data ID at the data exchange unit 51.

Next, the data exchange unit 51 of the communication management system 5 transmits, to the smartphone 9, the image data sent from the video conference terminal 3 (S103). This transmission includes an image data ID for identifying the image data as a transmission target. Thus, the smartphone 9 receives the image data, and the image data ID at the data exchange unit 91.

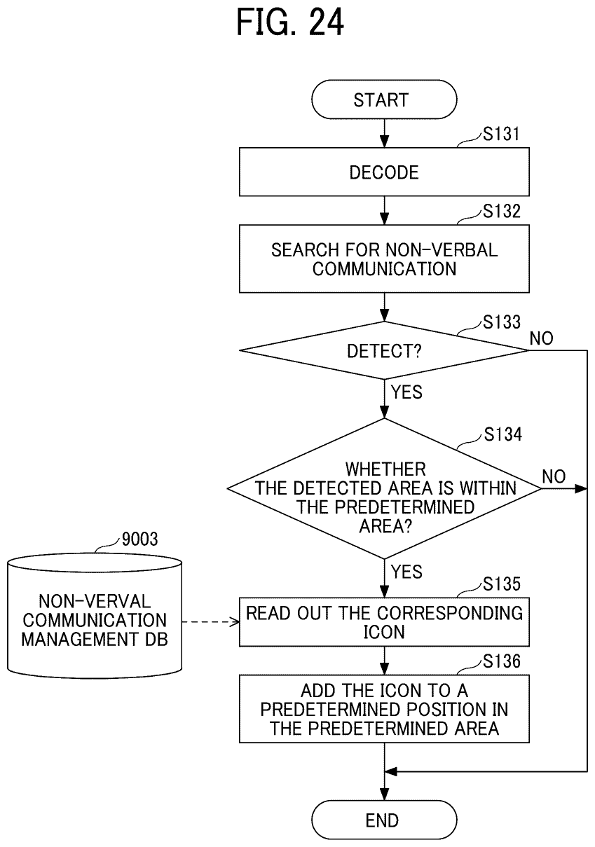

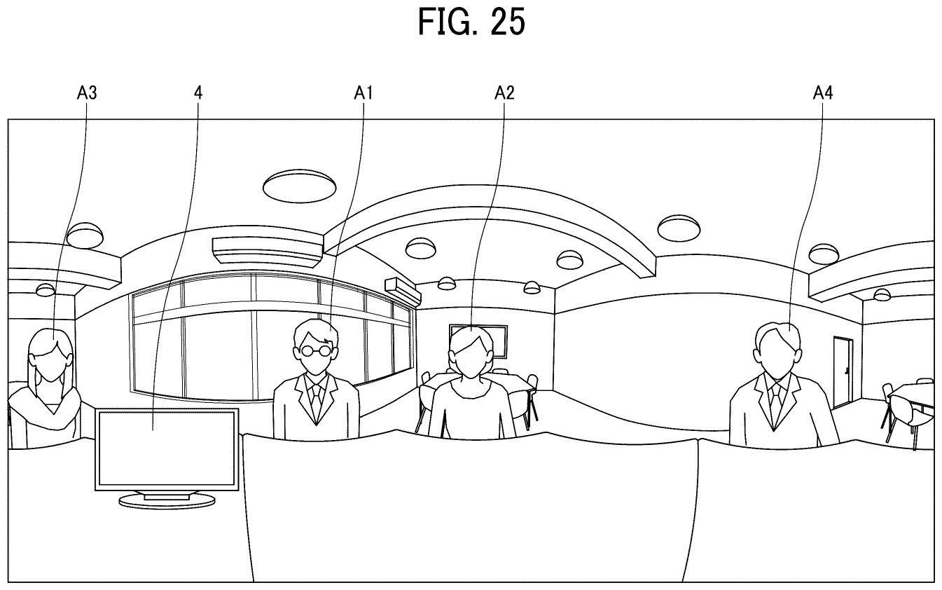

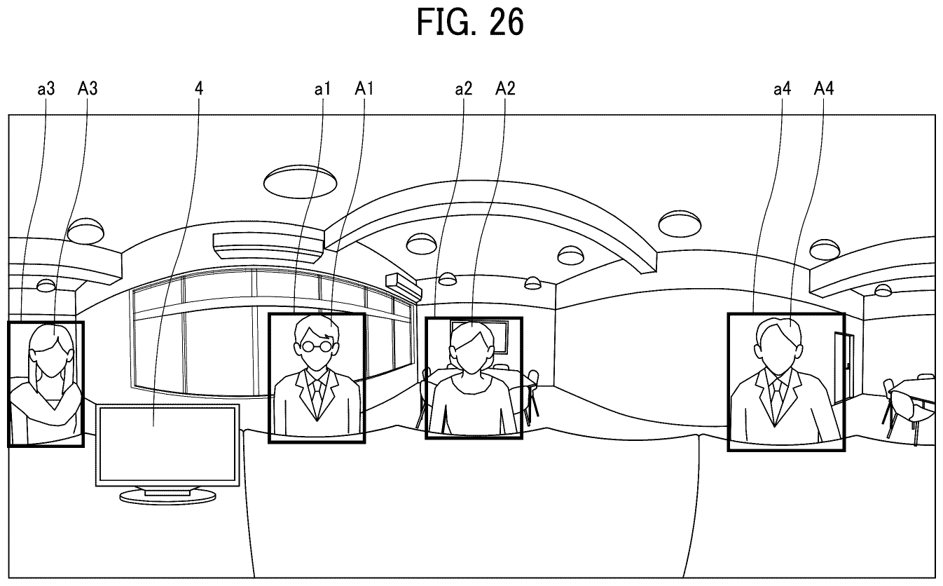

Next, the data storage/read unit 99 of the smartphone 9 searches the image type management DB 9001 (FIG. 14) using the image data ID received at S103 as a search key, to read out the image type information (source name) associated with the image data ID (S105). When the image type information indicates a special image (full spherical image, in this disclosure), i.e., when the image type information is “Video_Theta”, the image and audio processor 93 generates a full spherical image from the image data received at S103, and further generates a predetermined-area image (S105). This process will be described in detail later with reference to FIGS. 24 to 30.

Next, the display control 94 displays the predetermined-area image including the icon cl etc. in the display 917 of the smartphone 9. When the image type information indicates a general image, i.e., when the image type information is “Video”, the image and audio processor 93 does not generate a full spherical image from the image data received at S103. In this case, the display control 94 displays a general image.

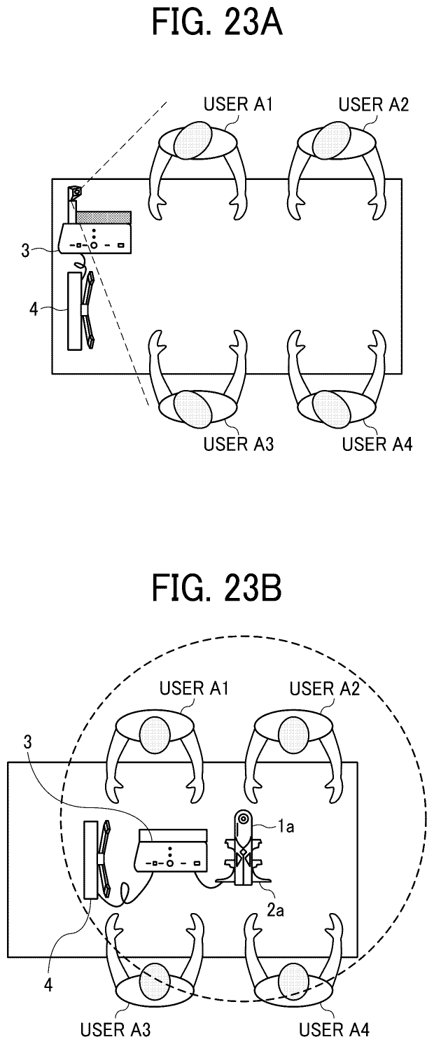

Next, referring to FIGS. 23A and 23B, a description is given of a state of video calling. FIGS. 23A and 23B illustrate example states of video calling. More specifically, FIG. 23A illustrates a case in which the image capturing device 1a is not used, while FIG. 23B illustrates a case in which the image capturing device 1a is used.

First, as illustrated in FIG. 23A, when the camera 312 (FIG. 10) that is built into the videoconference terminal 3 is used, that is, without using the image capturing device 1a, the videoconference terminal 3 has to be placed at the corner of a desk, so that the users A1 to A4 can be captured with the camera 312, because the angle of view is horizontally 125 degrees and vertically 70 degrees. This requires the users A1 to A4 to talk while looking in the direction of the videoconference terminal 3. Further, because the user A1 to A4 look in the direction of the videoconference terminal 3, the display 4 has also to be placed near the videoconference terminal 3. This requires the user A2 and the user A4, who are away from the videoconference terminal 3, to talk in a relatively loud voice, because they are away from the microphone 314 (FIG. 10). Further, it may be difficult for the user A2 and A4 to see contents displayed on the display 4.

### Processing for Generating a Predetermined Area Image

Next, the processing for generating a predetermined area image at site B will be explained using FIGS. 24 to 30.

As shown in FIG. 24, the image and audio processor 93 decodes the image data of the full spherical image received in process S103, and generates frame data at that time point (step S131).

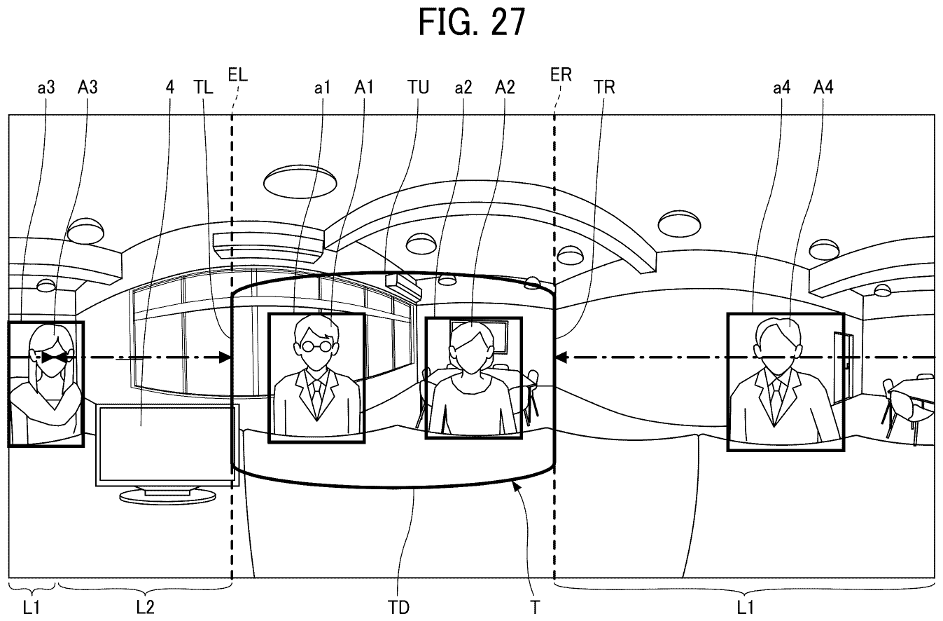

Next, the detection unit 37 searches for non-verbal communication from the images of people included in the spherical image, which is the decoded frame data (step S132). Here, step S132 will be described with reference to FIGS. 25 and 26. FIG. 25 is a diagram describing the full spherical image as an equirectangular projection image. FIG. 26 is a diagram describing a state in which each user is further detected in addition to the diagram shown in FIG. 25. The equirectangular projection image of the full spherical image transmitted by the video conference terminal 3 (an example of another communication terminal) at site A shown in FIG. 8 is shown as in FIG. 25. Here, as shown in FIG. 26, the detection unit 37 detects each of users A to D from the equirectangular projection image as shown in detection frames a1 to a4 (step S133). Furthermore, in step S133, the detection unit 37 searches for the state of non-verbal communication of each of users A to D in each of the detection frames a1 to a4. If non-verbal communication cannot be detected in step S133 (NO), the process shown in FIG. 24 ends.

On the other hand, if non-verbal communication is detected in step S132 (YES), the detection unit 37 determines whether the detected area is within the predetermined area to be displayed (step S134). Then, if the detected area is not within the predetermined area to be displayed in step S134 (NO), the processing shown in FIG. 24 ends. Then, the image and audio processor 33 may perform the processing of step S134.

On the other hand, in step S134, if the detected area is within the predetermined area to be displayed (YES), the storage/read unit 39 searches the non-verbal communication management DB 9003 using the content of the non-verbal communication detected by the detection unit 37 as a search key, and reads out the corresponding icon (step S135).

Finally, the image and audio processor 33 adds the icon read out by the storage/read unit 39 to a predetermined position in the predetermined area image (step S136). The display control unit 34 may also perform the processing of step S136. The processing of step S136 will now be explained in further detail using FIGS. 27 to 30. FIG. 27 is a diagram that further describes the distance between user A3 and the periphery of the predetermined area in addition to the diagram shown in FIG. 26. FIGS. 28 to 30 are diagrams showing example displays on the display at site B.

As shown in FIG. 27, when the predetermined area image displayed on display 917 includes users A1 and A2 but does not include users A3 and A4, the periphery of this predetermined area can be represented by a left frame TL, an upper frame TU, a right frame TR, and a lower frame TD. FIG. 27 also shows upper and lower extension lines EL of the left frame TL, and upper and lower extension lines ER of the right frame TR. Note that these frames and extension lines are not actually displayed on display 917.

In this case, the image and audio processor 33 derives a predetermined position that is the shortest distance from a predetermined part of the body of user A3 within the periphery of the predetermined area. The predetermined part is, for example, between the person's eyes or the person's nose. In the case of FIG. 27, the distance (the distance going all the way around) from the predetermined part of user A3 to the right frame TR is L1, and the distance from the predetermined part of user A3 to the left frame TL is L2. In FIG. 27, L2<L1. As a result, the image and sound processor 33 determines that the position of user A3 is close to the left side of the predetermined area, which is also the shortest distance. Therefore, as shown in FIG. 28, the image and sound processor 33 adds an icon cl corresponding to the content of user A3's non-verbal communication to the left side (left edge) of the predetermined area image displayed on the display 917, on the right extension of the predetermined part of user A3.

As a result, in step S106, the display control unit 34 can display a predetermined area image as shown in FIG. 28 on the display 917. This allows users B1 and B2 at site B to intuitively understand that a person to the left of user A1 and slightly below user A1's face in the full spherical image is worried about something, although he is not displayed, and that a person to the right of user A2 and slightly above user A2's face is clapping, although he is not displayed.

Note that users can change the predetermined area related to the predetermined area image in the same full spherical image. That is, users B1 and B2 can move their fingers on the touch panel 921 of the smartphone 9, and the reception unit 92 accepts the finger movement, and in response, the display control unit 94 changes the virtual viewpoint of the virtual camera IC shown in FIG. 7, thereby shifting, rotating, shrinking, or enlarging the specified area image. As a result, as shown in FIG. 28, even if only users A1 and A2, who are part of site A, are displayed in the initial setting (default), it is possible to shift the predetermined area image to display users A3 and A4.

Therefore, users B1 and B2 at site B can easily ask user A3 what he or she is having trouble with during the video conference by changing the virtual viewpoint of the predetermined area image shown in FIG. 28 to the right. In this case, for example, the display control unit 34 displays user A3 on the left and user A1 on the right within the predetermined area image.

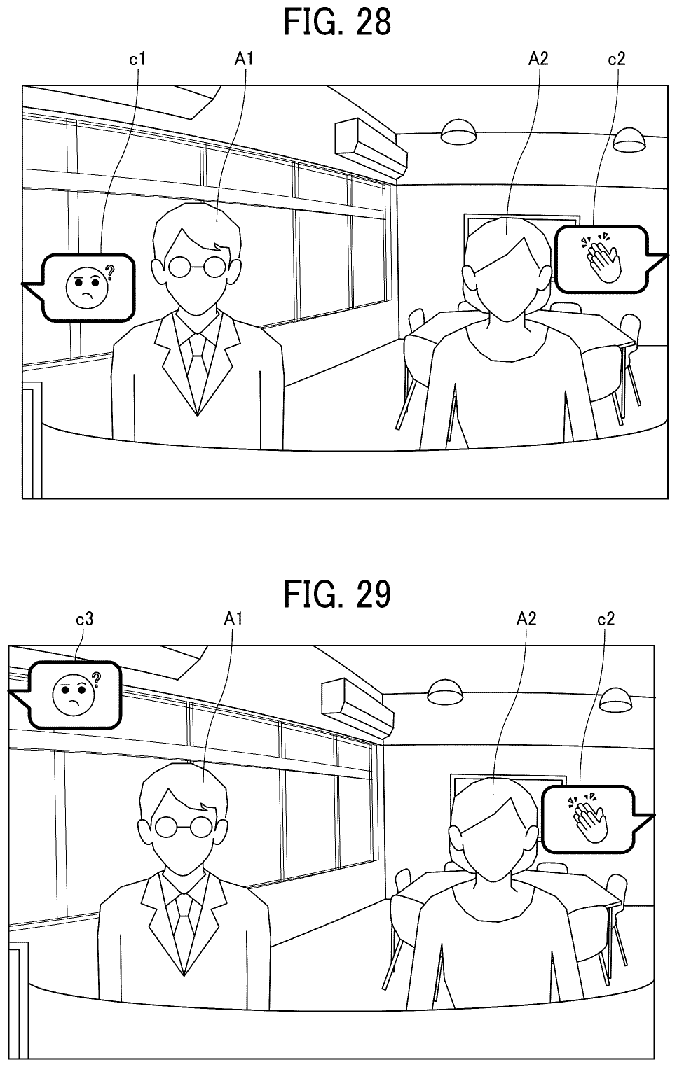

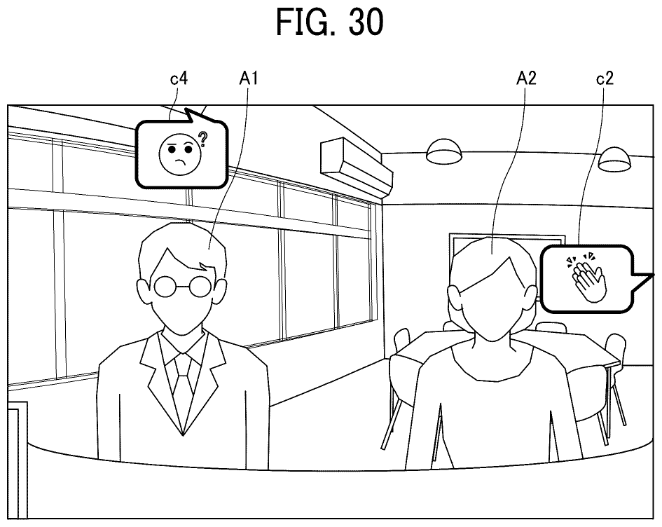

In addition, in FIG. 27, if user A3 is standing in the position shown in FIG. 27 and there is no right frame TR on the left extension line of the specified part of user A3, L1 will be the distance between the specified part of user A3 and the extension line ER. Similarly, if user A3 is standing and there is no left frame TL on the right extension line of the specified part of user A3, L2 will be the distance between the predetermined part of user A3 and the extension line EL. As a result, as shown in FIG. 29, icon c3 is added to the top left edge of the predetermined area image as the predetermined position. As a result, the shortest distance is between the left edge position of this predetermined area image and the predetermined part of user A3.

Also, in FIG. 27, if user A3 is standing directly behind user A1, the shortest distance from a designated part of user A3 to the upper frame TU is shorter than the shortest distance (the distance going all the way around) from a designated part of user A3 to the lower frame TD. As a result, as shown in FIG. 30, icon c4 is added directly above user A1 in the predetermined area image (the top edge of the designated area image) as the predetermined position. As a result, the shortest distance is between the position of the top edge of this predetermined area image and the predetermined part of user A3.

### Main Effects of the Present Embodiment

As described above, the present embodiment has the effect of making it easier for a user on the receiving side of a full spherical image (an example of a wide-field-of-view image) to understand the non-verbal communication of a person on the sending side that is included in an image other than a predetermined area of the full spherical image.

### Other Example

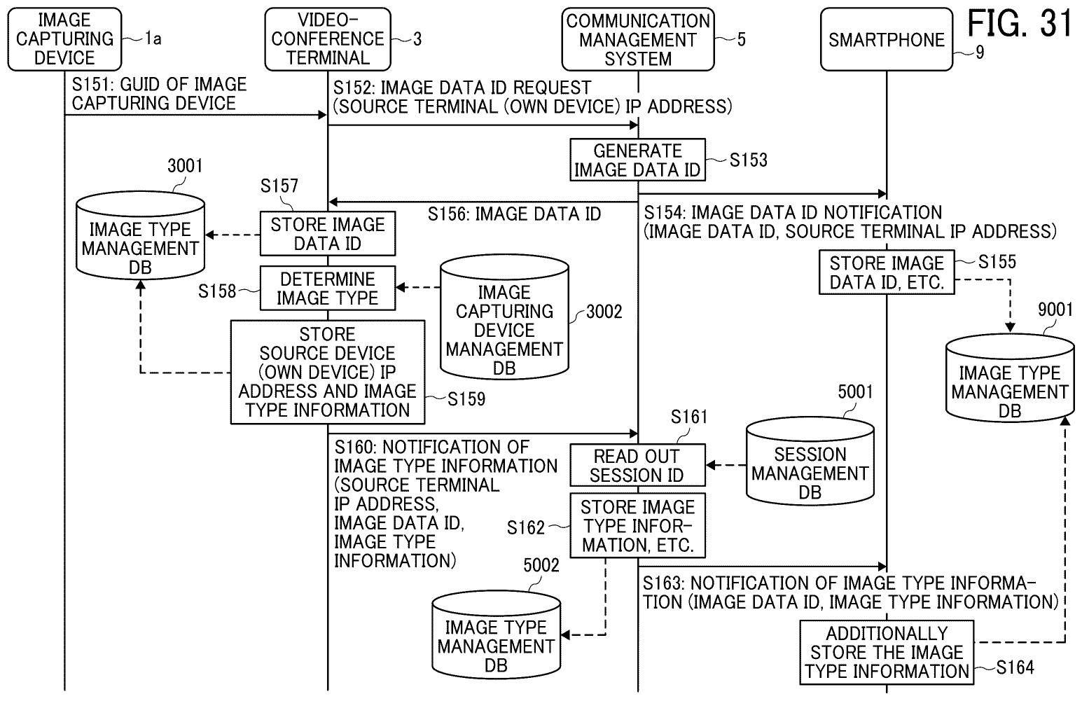

Other example of the management process of image type information will be described using FIG. 31. FIG. 31 is a sequence diagram showing other example of the management process of image type information.

First, when a user at site A (e.g., user A1) connects the USB cable of the cradle 2a with the image capturing device 1a attached to the videoconference terminal 3, the storage/read unit 19a of the image capturing device 1a reads out the GUID of its own device (image capturing device 1a) stored in the memory 1000a, and the communication unit 18a transmits the GUID of its own device to the communication unit 38 of the videoconference terminal 3 (step S151). As a result, the communication unit 38 of the videoconference terminal 3 receives the GUID of the image capturing device 1a.

Next, the data exchange unit 31 of the videoconference terminal 3 transmits a request for the image data ID to the communication management system 5 (step S152). This request includes the IP address of the videoconference terminal 3, which is the sending terminal (own terminal). As a result, the data exchange unit 51 of the communication management system 5 receives the request for the image data ID.

Next, the generator 56 generates a unique image data ID (step S153). The communication management system 5 then transmits a notification of the image data ID to the smartphone 9 (step S154). This notification includes the image data ID created in step S153 and the IP address of the video conference terminal 3 as the source terminal received in step S152. As a result, the data exchange unit 91 of the smartphone 9 receives the notification of the image data ID. Then, in the smartphone 9, the data storage/read unit 99 associates the image data ID and the IP address of the source terminal received in step S154 and stores them as a new record in the image type management DB 9001 (see FIG. 14) (step S155). Note that at this point, the image type information has not been associated and stored.

Meanwhile, in order to respond to the request for image data ID in step S152 above, the communication management system 5 causes the data exchange unit 51 to transmit the image data ID to the videoconference terminal 3 (step S156). As a result, the fata exchange unit 31 of the videoconference terminal 3 receives the image data ID. Then, in the videoconference terminal 3, the data storage/read unit 39 associates the image data ID received in step S156 with the IP address of the sender terminal (own terminal) managed by the videoconference terminal 3 and stores them as a new record in the image type management DB 3001 (see FIG. 14) (step S157). Note that at this point, the image type information has not been associated and stored.

Next, the determination unit 35 of the videoconferencing terminal 3 determines the image type by determining whether the same vendor ID and product ID as the vendor ID and product ID of the GUID received in step S151 are managed in the imaging device management DB 3002 (see FIG. 15) (step S158). This determination is the same as the process in step S52 above.

Next, the data storage/read unit 39 stores in the image type management DB 3001 (see FIG. 14) the image data ID already stored in step S157 in association with the IP address of the terminal itself (video conference terminal 3) which is the source terminal, and the image type information which is the result of the judgment made in step S158 (step S159). Then, the data exchange unit 31 transmits a notification of the image type information to the communication management system 5 (step S160). This notification of the image type information includes the image data ID stored in step S157, and the IP address and image type information of the terminal itself which is the source terminal stored in step S159. As a result, the data exchange unit 51 of the communication management system 5 receives the notification of the image type information.

Next, the data storage/read unit 59 of the communication management system 5 searches the session management DB 5001 (see FIG. 17) using the IP address of the source terminal received in step S160 as a search key, and reads out the corresponding session ID (step S161).

Next, the data storage/read unit 59 stores the session ID read in step S161, and the IP address of the sending terminal, the image data ID, and the image type information received in step S160 as a new record in the image type management DB 5002 (see FIG. 18) in association with each other (step S162). Then, the communication management system 5 transmits a notification of the image type information to the smartphone 9, which is another communication terminal (step S163). This notification of the image type information includes the image data ID and image type information stored in step S162. As a result, the data exchange unit 91 of the smartphone 9 receives the notification of the image type information.

Next, the data storage/read unit 99 of the smartphone 9 associates the image type information received in step S163 with the image data ID that is the same as the image data ID received in step S163 and additionally stores the image type information in the image type management DB 9001 (see FIG. 14) (step S164). This ends the management process of the image type information.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

What is claimed is:

1. A communication terminal, comprising:
circuitry configured to:
receive, from another communication terminal, a wide-field-of-view image;
display a particular area image corresponding to a particular area of the wide-field-of-view image; and
display an icon, corresponding to a non-verbal communication of a person, at a position in the particular area image in a case that the non-verbal communication is detected in an area of the wide-field-of-view image outside of the particular area.

2. The communication terminal of claim 1, wherein the circuitry is further configured to analyze the wide-field-of-view image to detect whether the non-verbal communication is included in the area outside of the particular area.

3. The communication terminal of claim 2, wherein the circuitry is further configured to
communicate with a database in response to detection of the non-verbal communication in the area outside of the particular area, and
receive data indicating the icon corresponding to the non-verbal communication from the database.

4. The communication terminal of claim 1, wherein the non-verbal communication includes any of a facial expression, a complexion, a gaze, a gesture, a hand gesture, and a body posture regarding the person.

5. The communication terminal of claim 1, wherein the position is in the particular area and at a position along a line directed toward a part of the person's body.

6. The communication terminal of claim 5, wherein the part is between the person's eyes or the person's nose.

7. The communication terminal of claim 1, wherein the circuitry is further configured to
detect the non-verbal communication of the person included in the area outside of the particular area of the wide-field-of-view image; and
display the icon corresponding to the detected non-verbal communication at the position in the particular area.

8. The communication terminal of claim 7, further comprising:
a memory storing a content of the non-verbal communication in association with the icon, wherein
the circuitry displays the icon corresponding to the non-verbal communication stored in the memory at the position in the particular area.

9. The communication terminal of claim 1, wherein the communication terminal receives the wide-field-of-view image from an image capturing device.

10. The communication terminal of claim 1, wherein the circuitry is further configured to display a plurality of icons, each icon of the plurality of icons corresponding to a respective non-verbal communication of a plurality of non-verbal communications, and each non-verbal communication of the plurality of non-verbal communications being of a respective person in the area of the wide-field-of-view image outside of the particular area.

11. The communication terminal of claim 10, wherein the plurality of icons are displayed at different positions in the particular area.

12. A displaying method performed by a communication terminal, the displaying method comprising:
receiving, from another communication terminal, wide-field-of-view image;
displaying a particular area image corresponding to a particular area of the wide-field-of-view image; and
displaying an icon, corresponding to a non-verbal communication of a person, at a position in the particular area image in a case that the non-verbal communication is detected in an area of the wide-field-of-view image outside of the particular area.

13. The displaying method of claim 12, further comprising analyzing the wide-field-of-view image to detect whether the non-verbal communication is included in the area outside of the particular area.

14. The displaying method of claim 12, further comprising:
communicating with a database in response to detection of the non-verbal communication in the area outside of the particular area; and
receiving data indicating the icon corresponding to the non-verbal communication from the database.

15. The displaying method of claim 12, wherein the non-verbal communication includes any of a facial expression, a complexion, a gaze, a gesture, a hand gesture, and a body posture regarding the person.

16. The displaying method of claim 12, wherein the position is in the particular area and at a position along a line directed toward a part of the person's body.

17. The displaying method of claim 16, wherein the part is between the person's eyes or the person's nose.

18. The displaying method of claim 12, further comprising:
detecting the non-verbal communication of the person included in the area outside of the particular area of the wide-field-of-view image; and
displaying the icon corresponding to the detected non-verbal communication at the position in the particular area.

19. The displaying method of claim 18, further comprising:
storing a content of the non-verbal communication in association with the icon; and
displaying the icon corresponding to the non-verbal communication stored in the memory at the position in the particular area.

20. A non-transitory computer readable medium storing computer executable instructions which, when executed by circuitry of a communication terminal, cause the communication terminal to:
receive, from another communication terminal, a wide-field-of-view image;
display a particular area image corresponding to a particular area of the wide-field-of-view image; and
display an icon, corresponding to a non-verbal communication of a person, at a position in the particular area image in a case that the non-verbal communication is detected in an area of the wide-field-of-view image outside of the particular area.
